(19) United States
(12) Patent Application Publication
(10) Pub. No.: US 2026/0052246 A1
(43) Pub. Date: Feb. 19, 2026

(54) METHOD, APPARATUS, AND MEDIUM FOR VIDEO PROCESSING

(71) Applicant: Douyin Vision Co., Ltd., Beijing (CN)

(72) Inventors: Chaoyi LIN, Beijing (CN); Junru LI, Beijing (CN)

(21) Appl. No.: 19/369,037

(22) Filed: Oct. 24, 2025

Related U.S. Application Data
(63) Continuation of application No. PCT/CN2024/089598, filed on Apr. 24, 2024.

(30) Foreign Application Priority Data
Apr. 24, 2024 (WO) PCT/CN2023/090713

(51) Int. Cl. H04N 19/117; H04N 19/174; H04N 19/186; H04N 19/82

(52) U.S. Cl. CPC H04N 19/117; H04N 19/174; H04N 19/186; H04N 19/82

(57) ABSTRACT

Embodiments of the disclosure provide a solution for video processing. A method for video processing is proposed. The method includes: determining, during a conversion between a video unit of a video and a bitstream of the video, a neural network filter comprising a multi-scale neural network structure that comprises a plurality of branches; applying the neural network filter to the video unit; and performing the conversion based on the filtered video unit.

### CROSS-REFERENCE

This application is a continuation of International Application No. PCT/CN2024/089598, filed on Apr. 24, 2024, which claims the benefit of International Application No. PCT/CN2023/090713, filed on Apr. 25, 2023. The entire contents of these applications are hereby incorporated by reference in their entireties.

### FIELD

Embodiments of the present disclosure relates generally to video processing techniques, and more particularly, to designing a neural network-based in-loop filtering for video coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, during a conversion between a video unit of a video and a bitstream of the video, a neural network filter comprising a multi-scale neural network structure that comprises a plurality of branches; applying the neural network filter to the video unit; and performing the conversion based on the filtered video unit. In this way, it can improve the performance of filtering and reduce the complexity of the filter.

In a second aspect, another method for video processing is proposed. The method comprises: determining, during a conversion between a video unit of a video and a bitstream of the video, a neural network filter, wherein the neural network filter is used for at least one of: luma component or chroma component, and/or the neural network filter is used for at least one of: intra slice or inter slice; applying the neural network filter to the video unit; and performing the conversion based on the filtered video unit. In this way, it can improve the performance of filtering and reduce the complexity of the filter.

In a third aspect, an apparatus for video processing is proposed. The apparatus comprises a processor and a non-transitory memory with instructions thereon. The instructions upon execution by the processor, cause the processor to perform a method in accordance with the first, or second aspect of the present disclosure.

In a fourth aspect, a non-transitory computer-readable storage medium is proposed. The non-transitory computer-readable storage medium stores instructions that cause a processor to perform a method in accordance with the first, or second aspect of the present disclosure.

In a fifth aspect, another non-transitory computer-readable recording medium is proposed. The non-transitory computer-readable recording medium stores a bitstream of a video which is generated by a method performed by an apparatus for video processing. The method comprises: determining a neural network filter comprising a multi-scale neural network structure that comprises a plurality of branches; applying the neural network filter to the video unit; applying the neural network filter to a video unit of the video; and generating the bitstream based on the filtered video unit.

In a sixth aspect, a method for storing a bitstream of a video is proposed. The method comprises: determining a neural network filter comprising a multi-scale neural network structure that comprises a plurality of branches; applying the neural network filter to the video unit; applying the neural network filter to a video unit of the video; generating the bitstream based on the filtered video unit; and storing the bitstream in a non-transitory computer-readable recording medium.

In a seventh aspect, another non-transitory computer-readable recording medium is proposed. The non-transitory computer-readable recording medium stores a bitstream of a video which is generated by a method performed by an apparatus for video processing. The method comprises: determining a neural network filter, wherein the neural network filter is used for at least one of: luma component or chroma component, and/or the neural network filter is used for at least one of: intra slice or inter slice; applying the neural network filter to the video unit; applying the neural network filter to a video unit of the video; and generating the bitstream based on the filtered video unit.

In an eighth aspect, a method for storing a bitstream of a video is proposed. The method comprises: determining a neural network filter, wherein the neural network filter is used for at least one of: luma component or chroma component, and/or the neural network filter is used for at least one of: intra slice or inter slice; applying the neural network filter to the video unit; applying the neural network filter to a video unit of the video; generating the bitstream based on the filtered video unit; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example of raster-scan slice partitioning of a picture;

FIG. 5 illustrates an example of rectangular slice partitioning of a picture;

FIG. 6 illustrates an example of a picture partitioned into tiles, bricks, and rectangular slices;

FIG. 7A illustrates an example diagram showing CTBs crossing the bottom picture border;

FIG. 7B illustrates an example diagram showing CTBs crossing the right picture border;

FIG. 7C illustrates an example diagram showing CTBs crossing the right bottom picture border;

FIG. 8 illustrates an example of encoder block diagram of VVC;

FIG. 9 illustrates picture samples and horizontal and vertical block boundaries on the 8×8 grid, and the non-overlapping blocks of the 8×8 samples;

FIG. 10 illustrates pixels involved in filter on/off decision and strong/weak filter selection;

FIGS. 11A-11D illustrate example diagrams showing four 1-D directional patterns for EO sample classification;

FIGS. 12A-12C illustrate example diagrams showing examples of GALF filter shapes;

FIGS. 13A-13C illustrate example diagrams showing examples of relative coordinator for the 5×5 diamond filter support;

FIG. 14 illustrates an example diagram showing examples of relative coordinates for the 5×5 diamond filter support;

FIG. 15A illustrates an example diagram showing Architecture of the proposed CNN filter;

FIG. 15B illustrates an example diagram showing a construction of ResBlock (residual block) in the CNN filter;

FIG. 16 illustrates an example neural network with two branches;

FIG. 17 illustrates a first example network structure of NN filter;

FIG. 18 illustrates a second example network structure of NN filter;

FIG. 19 illustrates a third example network structure of NN filter;

FIG. 20 illustrates a fourth example network structure of NN filter;

FIG. 21 illustrates a fifth example network structure of NN filter;

FIG. 22 illustrates a sixth example network structure of NN filter;

FIG. 23 illustrates an example structure of a luma model;

FIG. 24 illustrates an example structure of a chroma model;

FIG. 25 illustrates an example structure of a single model used for generating the output of luma and chroma components together;

FIG. 26 illustrates a flowchart of a method for video processing in accordance with embodiments of the present disclosure;

FIG. 27 illustrates a flowchart of a method for video processing in accordance with embodiments of the present disclosure; and

FIG. 28 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

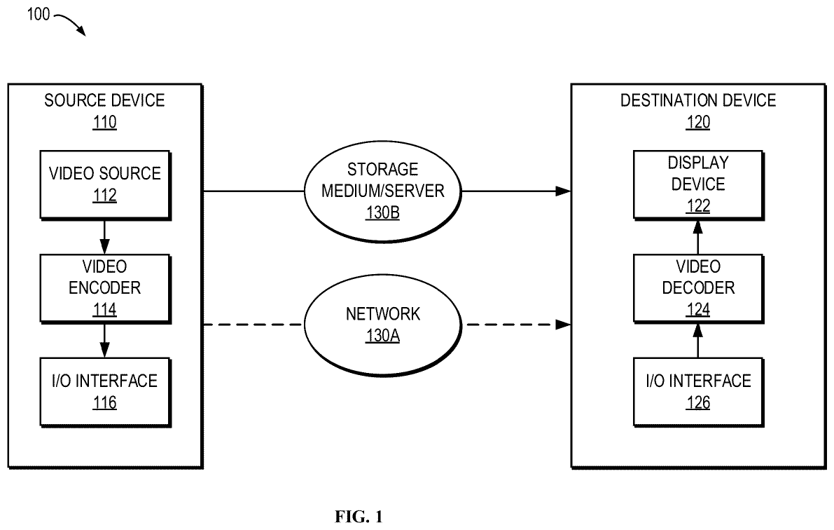

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

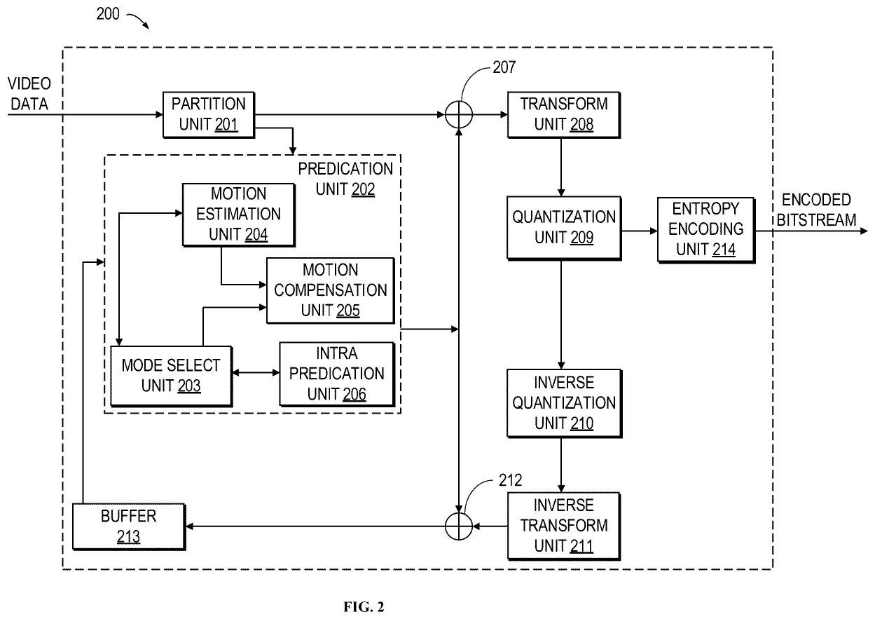

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

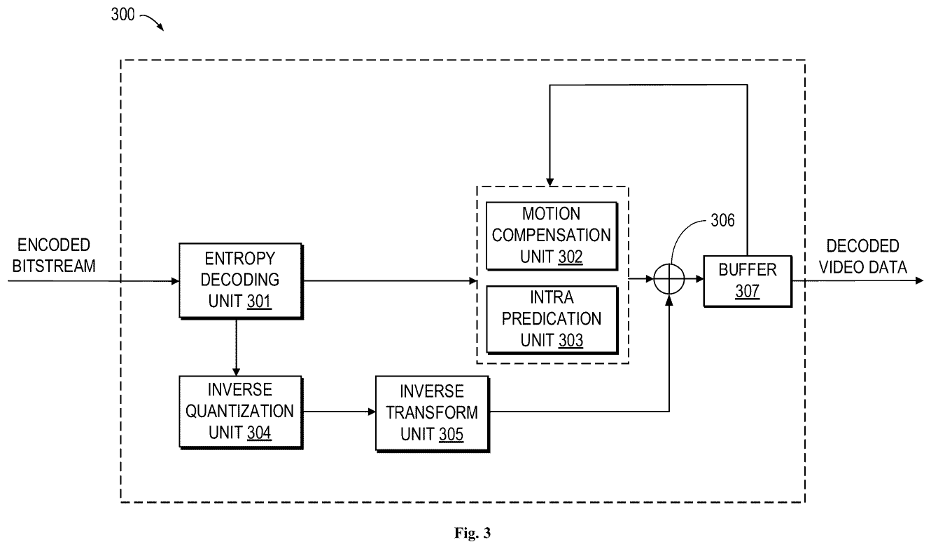

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Initial Discussion

The present disclosure is related to video coding technologies. Specifically, it is related to the loop filter in image/video coding. It may be applied to the existing video coding standard like High-Efficiency Video Coding (HEVC), Versatile Video Coding (VVC), or the standard (e.g., AVS3) to be finalized. It may be also applicable to future video coding standards or video codec or being used as post-processing method which is out of encoding/decoding process.

### 2. Background

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by WET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC. VVC version 1 was finalized in July 2020.

### 2.1. Color Space and Chroma Subsampling

Color space, also known as the color model (or color system), is an abstract mathematical model which simply describes the range of colors as tuples of numbers, typically as 3 or 4 values or color components (e.g. RGB). Basically speaking, color space is an elaboration of the coordinate system and sub-space.

For video compression, the most frequently used color spaces are YCbCr and RGB.

YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma subsampling is the practice of encoding images by implementing less resolution for chroma information than for luma information, taking advantage of the human visual system's lower acuity for color differences than for luminance.

2.1.1. 4:4:4

Each of the three Y′CbCr components have the same sample rate, thus there is no chroma subsampling. This scheme is sometimes used in high-end film scanners and cinematic post production.

2.1.2. 4:2:2

The two chroma components are sampled at half the sample rate of luma: the horizontal chroma resolution is halved. This reduces the bandwidth of an uncompressed video signal by one-third with little to no visual difference.

2.1.3. 4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.

In MPEG-2, Cb and Cr are cosited horizontally. Cb and Cr are sited between pixels in the vertical direction (sited interstitially).

In JPEG/JFIF, H.261, and MPEG-1, Cb and Cr are sited interstitially, halfway between alternate luma samples. In 4:2:0 DV, Cb and Cr are co-sited in the horizontal direction. In the vertical direction, they are co-sited on alternating lines.

### 2.2. Definitions of Video Units

A picture is divided into one or more tile rows and one or more tile columns. A tile is a sequence of CTUs that covers a rectangular region of a picture.

A tile is divided into one or more bricks, each of which consisting of a number of CTU rows within the tile.

A tile that is not partitioned into multiple bricks is also referred to as a brick. However, a brick that is a true subset of a tile is not referred to as a file.

A slice either contains a number of files of a picture or a number of bricks of a tile.

Two modes of slices are supported, namely the raster-scan slice mode and the rectangular slice mode. In the raster-scan slice mode, a slice contains a sequence of files in a tile raster scan of a picture. In the rectangular slice mode, a slice contains a number of bricks of a picture that collectively form a rectangular region of the picture. The bricks within a rectangular slice are in the order of brick raster scan of the slice.

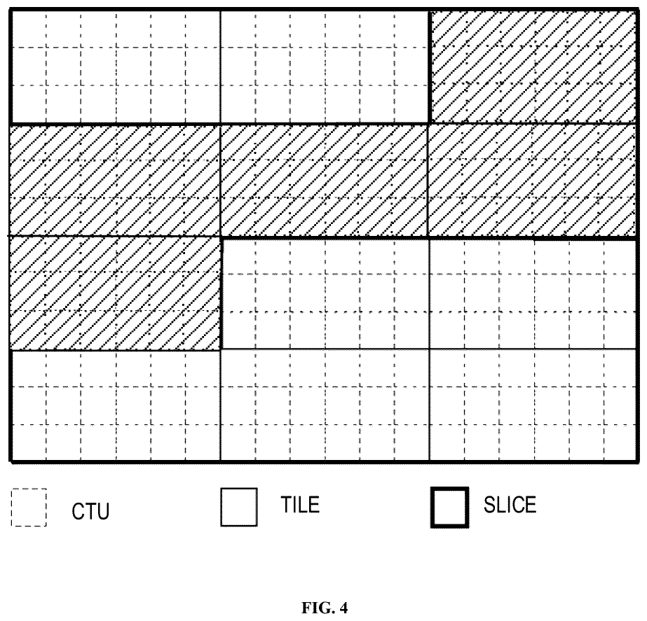

FIG. 4 shows an example of raster-scan slice partitioning of a picture, where the picture is divided into 12 tiles and 3 raster-scan slices. In FIG. 4, a picture with 18 by 12 luma CTUs is partitioned into 12 tiles and 3 raster-scan slices (informative).

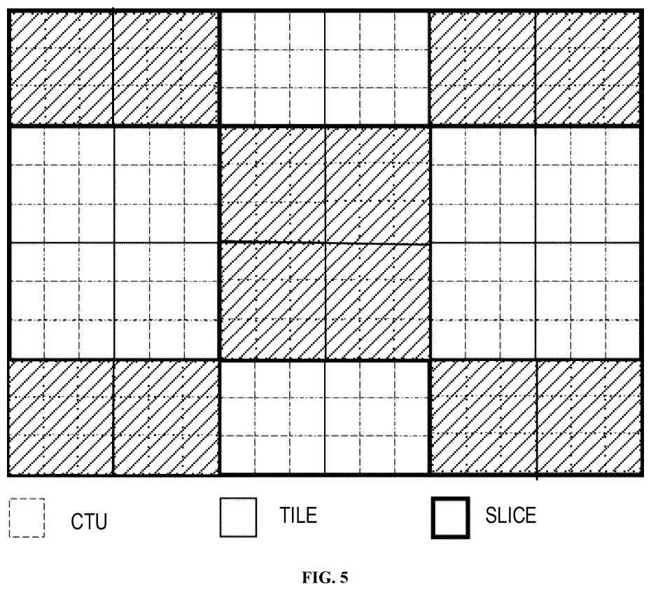

FIG. 5 in the VVC specification shows an example of rectangular slice partitioning of a picture, where the picture is divided into 24 tiles (6 tile columns and 4 tile rows) and 9 rectangular slices. In FIG. 5, a picture with 18 by 12 luma CTUs is partitioned into 24 tiles and 9 rectangular slices (informative).

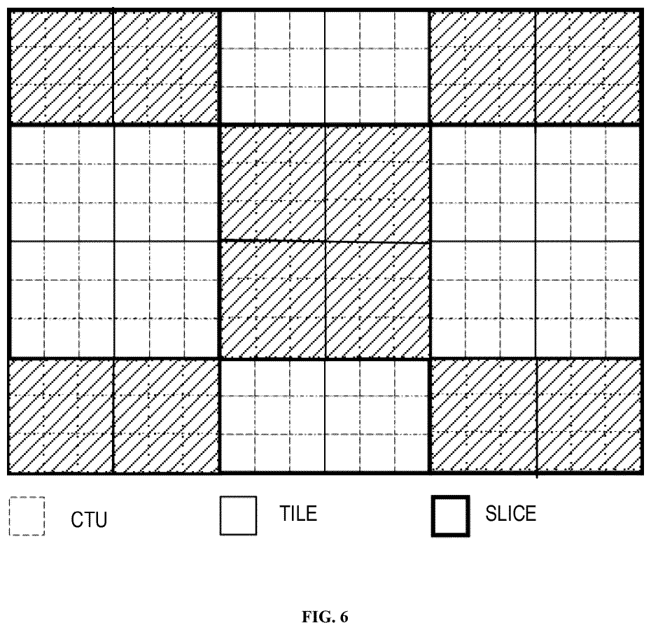

FIG. 6 in the VVC specification shows an example of a picture partitioned into files, bricks, and rectangular slices, where the picture is divided into 4 files (2 tile columns and 2 tile rows), 11 bricks (the top-left tile contains 1 brick, the top-right tile contains 5 bricks, the bottom-left tile contains 2 bricks, and the bottom-right tile contain 3 bricks), and 4 rectangular slices. In FIG. 6, a picture is partitioned into 4 tiles, 11 bricks, and 4 rectangular slices (informative).

2.2.1. CTU/CTB sizes

In VVC, the CTU size, signaled in SPS by the syntax element log 2_ctu_size_minus2, could be as small as 4×4.

### 7.3.2.3 Sequence Parameter Set RBSP Syntax

| | Descriptor |
|---|---|
| seq_parameter_set_rbsp( ) { | |
| sps_decoding_parameter_set_id | u(4) |
| sps_video_parameter_set_id | u(4) |
| sps_max_sub_layers_minus1 | u(3) |
| sps_reserved_zero_5bits | u(5) |
| profile_tier_level( sps_max_sub_layers_minus1 ) | |
| gra_enabled_flag | u(1) |
| sps_seq_parameter_set_id | ue(v) |
| chroma_format_idc | ue(v) |
| if( chroma_format_idc = = 3 ) | |
| separate_colour_plane_flag | u(1) |
| pic_width_in_luma_samples | ue(v) |
| pic_height_in_luma_samples | ue(v) |
| conformance_window_flag | u(1) |
| if( conformance_window_flag ) { | |
| conf_win_left_offset | ue(v) |
| conf_win_right_offset | ue(v) |
| conf_win_top_offset | ue(v) |
| conf_win_bottom_offset | ue(v) |
| } | |
| bit_depth_luma_minus8 | ue(v) |
| bit_depth_chroma_minus8 | ue(v) |
| log2_max_pic_order_cnt_lsb_minus4 | ue(v) |
| sps_sub_layer_ordering_info_present_flag | u(1) |
| for( i = ( sps_sub_layer_ordering_info_present_flag ? 0 : sps_max_sub_layers_minus1 ); | |
| i <= sps_max_sub_layers_minus1; i++ ) { | |
| sps_max_dec_pic_buffering_minus1[ i ] | ue(v) |
| sps_max_num_reorder_pics[ i ] | ue(v) |
| sps_max_latency_increase_plus1[ i ] | ue(v) |
| } | |
| long_term_ref_pics_flag | u(1) |
| sps_idr_rpl_present_flag | u(1) |
| rpl1_same_as_rpl0_flag | u(1) |
| for( i = 0; i < !rpl1_same_as_rpl0_flag ? 2 : 1; i++ ) { | |
| num_ref_pic_lists_in_sps[ i ] | ue(v) |
| for( j = 0; j < num_ref_pic_lists_in_sps[ i ]; j++) | |
| ref_pic_list_struct( i, j ) | |
| } | |
| qtbtt_dual_tree_intra_flag | u(1) |
| log2_ctu_size_minus2 | ue(v) |
| log2_min_luma_coding_block_size_minus2 | ue(v) |
| partition_constraints_override_enabled_flag | u(1) |
| sps_log2_diff_min_qt_min_cb_intra_slice_luma | ue(v) |
| sps_log2_diff_min_qt_min_cb_inter_slice | ue(v) |
| sps_max_mtt_hierarchy_depth_inter_slice | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_max_mtt_hierarchy_depth_inter_slices != 0 ) { | |
| sps_log2_diff_max_bt_min_qt_inter_slice | ue(v) |
| sps_log2_diff_max_tt_min_qt_inter_slice | ue(v) |
| } | |
| if( qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if ( sps_max_mtt_hierarchy_depth_intra_slice_chroma != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| ... | |
| rbsp_trailing_bits( ) | |
| } | |

log 2_ctu_size_minus2 plus 2 specifies the luma coding tree block size of each CTU.

log 2_min_luma_coding_block_size_minus2 plus 2 specifies the minimum luma coding block size. The variables CtbLog 2SizeY, CtbSizeY, MinCbLog 2SizeY, MinCbSizeY, MinTbLog 2SizeY, MaxTbLog 2SizeY, MinTbSizeY, MaxTbSizeY, PicWidthInCtbsY, PicHeightInCtbsY, PicSizeInCtbsY, PicWidthInMinCbsY, PicHeightInMinCbsY, PicSizeInMinCbsY, PicSizeInSamplesY, PicWidthInSamplesC and PicHeightInSamplesC are derived as follows:

$$Ctb Log 2 SizeY = log 2 \_ctu \_size \_minus2 + 2 \qquad ( 7 - 9 )$$

$$CtbSizeY = 1 ≪ Ctb Log 2 SizeY \qquad ( 7 - 10 )$$

$$Min Cb Log 2 SizeY = log2\_min \_luma \_coding \_block \_size \_minus2 + 2 \qquad ( 7 - 11 )$$

$$Min Cb SizeY = 1 ≪ Min Cb Log 2 SizeY \qquad ( 7 - 12 )$$

$$Min Tb Log 2 SizeY = 2 \qquad ( 7 - 13 )$$

$$Max Tb Log 2 SizeY = 6 \qquad ( 7 - 14 )$$

$$Min TbSizeY = 1 ≪ Min Tb Log 2 SizeY \qquad ( 7 - 15 )$$

$$Max TbSizeY = 1 ≪ Max Tb Log 2 SizeY \qquad ( 7 - 16 )$$

$$PicWidthInCtbsY = Ceil ( pic\_width \_in \_luma \_samples \div CtbSizeY ) \qquad ( 7 - 17 )$$

$$PicHeightInCtbsY = Ceil ( pic\_height \_in \_luma \_samples \div CtbSizeY ) \qquad ( 7 - 18 )$$

$$PicSizeInCtbsY = PicWidthInCtbsY * PicHeightInCtbsY \qquad ( 7 - 19 )$$

$$PicWidthIn Min CbsY = pic\_width \_in \_luma \_samples / Min CbSizeY \qquad ( 7 - 20 )$$

$$PicHeightIn Min CbsY = pic\_height \_in \_luma \_samples / Min CbSizeY \qquad ( 7 - 21 )$$

$$PicSizeIn Min CbsY = PicWidthIn Min CbsY * PicHeightIn Min CbsY \qquad ( 7 - 22 )$$

$$PicSizeInSamplesY = pic\_width \_in \_luma \_samples * pic\_height \_in \_luma \_samples \qquad ( 7 - 23 )$$

$$PicWidthInSamplesC = pic\_width \_in \_luma \_samples / SubWidthC \qquad ( 7 - 24 )$$

$$PicHeightInSamplesC = pic\_height \_in \_luma \_samples / SubHeightC \qquad ( 7 - 25 )$$

### 2.2.2. CTUs in a Picture

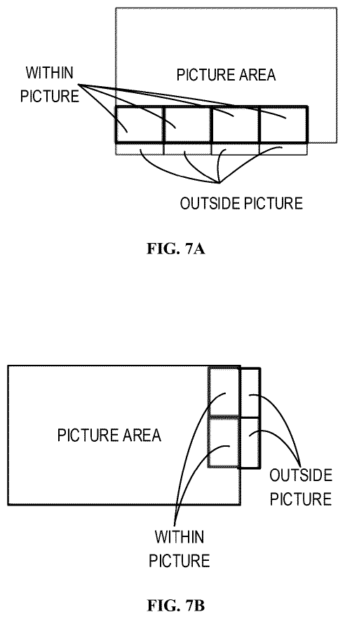

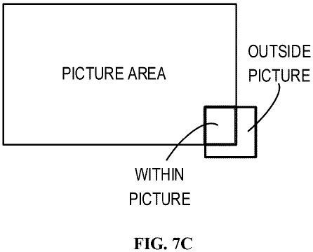

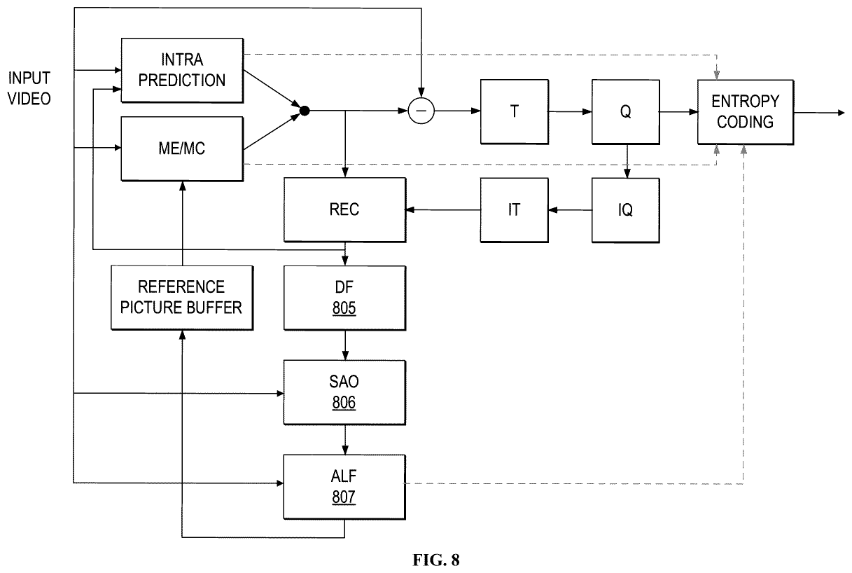

Suppose the CTB/LCU size indicated by M×N (typically M is equal to N, as defined in HEVC/VVC), and for a CTB located at picture (or file or slice or other kinds of types, picture border is taken as an example) border, K×L samples are within picture border wherein either K<M or L<N. For those CTBs as depicted in FIG. 7A to FIG. 7C, the CTB size is still equal to M×N, however, the bottom boundary/right boundary of the CTB is outside the picture.

FIG. 7A to FIG. 7C shows examples of CTBs crossing picture borders, FIG. 7A shows K=M, L<N; FIG. 7B K<M, L=N; FIG. 7C K<M, L<N.

### 2.3. Coding Flow of a Typical Video Codec

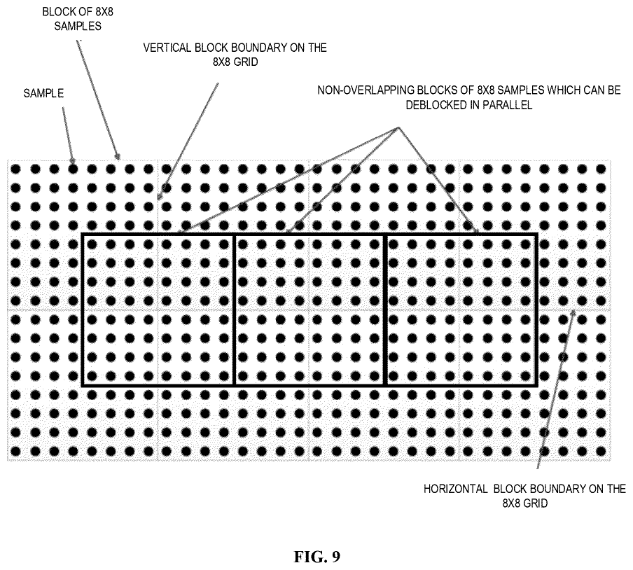

FIG. 8 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signaling the offsets and filter coefficients. ALF is located at the last processing stage of each picture and can be regarded as a tool trying to catch and fix artifacts created by the previous stages.

### 2.4. Deblocking Filter (DB)

The input of DB is the reconstructed samples before in-loop filters.

The vertical edges in a picture are filtered first. Then the horizontal edges in a picture are filtered with samples modified by the vertical edge filtering process as input. The vertical and horizontal edges in the CTBs of each CTU are processed separately on a coding unit basis. The vertical edges of the coding blocks in a coding unit are filtered starting with the edge on the left-hand side of the coding blocks proceeding through the edges towards the right-hand side of the coding blocks in their geometrical order. The horizontal edges of the coding blocks in a coding unit are filtered starting with the edge on the top of the coding blocks proceeding through the edges towards the bottom of the coding blocks in their geometrical order.

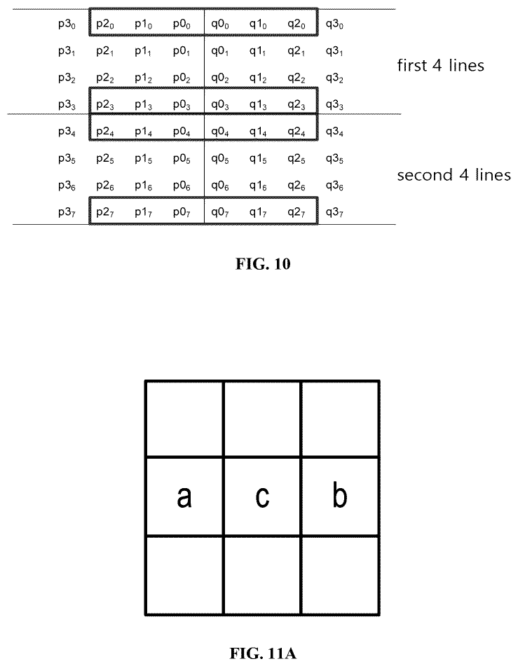

FIG. 9 illustrates picture samples and horizontal and vertical block boundaries on the 8×8 grid, and the nonoverlapping blocks of the 8×8 samples, which can be deblocked in parallel.

### 2.4.1. Boundary Decision

Filtering is applied to 8×8 block boundaries. In addition, it must be a transform block boundary or a coding subblock boundary (e.g., due to usage of Affine motion prediction, ATMVP). For those which are not such boundaries, filter is disabled.

### 2.4.2. Boundary Strength Calculation

For a transform block boundary/coding subblock boundary, if it is located in the 8×8 grid, it may be filtered and the setting of bS[xDᵢ][yDⱼ](wherein [xDᵢ][yDᵢ] denotes the coordinate) for this edge is defined in Table 1 and Table 2, respectively.

TABLE 1
Boundary strength (when SPS IBC is disabled)

| Priority | Conditions | Y | U | V |
|---|---|---|---|---|
| 5 | At least one of the adjacent blocks is intra | 2 | 2 | 2 |
| 4 | TU boundary and at least one of the adjacent | 1 | 1 | 1 |
| | blocks has non-zero transform coefficients | | | |
| 3 | Reference pictures or number of MVs (1 for | 1 | N/A | N/A |
| | uni-prediction, 2 for bi-prediction) of the | | | |
| | adjacent blocks are different | | | |
| 2 | Absolute difference between the motion | 1 | N/A | N/A |
| | vectors of same reference picture that | | | |
| | belong to the adjacent blocks is greater | | | |
| | than or equal to one integer luma sample | | | |
| 1 | Otherwise | 0 | 0 | 0 |

TABLE 2
Boundary strength (when SPS IBC is enabled)

| Priority | Conditions | Y | U | V |
|---|---|---|---|---|
| 8 | At least one of the adjacent blocks is intra | 2 | 2 | 2 |
| 7 | TU boundary and at least one of the adjacent | 1 | 1 | 1 |
| | blocks has non-zero transform coefficients | | | |
| 6 | Prediction mode of adjacent blocks is | 1 | | |
| | different (e.g., one is IBC, one is inter) | | | |
| 5 | Both IBC and absolute difference between | 1 | N/A | N/A |
| | the motion vectors that belong to the | | | |
| | adjacent blocks is greater than or equal | | | |
| | to one integer luma sample | | | |
| 4 | Reference pictures or number of MVs (1 for | 1 | N/A | N/A |
| | uni-prediction, 2 for bi-prediction) of the | | | |
| | adjacent blocks are different | | | |
| 3 | Absolute difference between the motion | 1 | N/A | N/A |
| | vectors of same reference picture that | | | |
| | belong to the adjacent blocks is greater | | | |
| | than or equal to one integer luma sample | | | |
| 1 | Otherwise | 0 | 0 | 0 |

### 2.4.3. Deblocking Decision for Luma Component

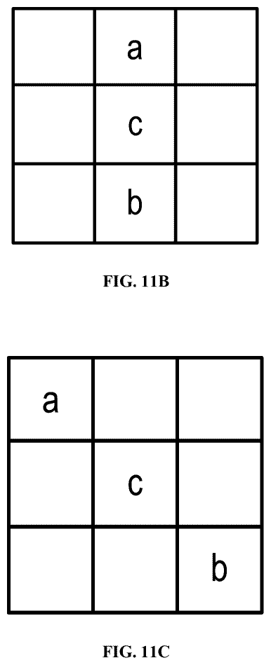

The deblocking decision process is described in this sub-section. FIG. 10 shows pixels involved in filter on/off decision and strong/weak filter selection.

Wider-stronger luma filter is filters are used only if all the Condition1, Condition2 and Condition 3 are TRUE.

The condition 1 is the “large block condition”. This condition detects whether the samples at P-side and Q-side belong to large blocks, which are represented by the variable bSidePisLargeBlk and bSideQisLargeBlk respectively. The bSidePisLargeBlk and bSideQisLargeBlk are defined as follows.

$$bSidePisLargeBlk = ( ( edge type is vertical and {p}_{0} belongs to CU with width >= 32 ) ‖ ( edge type is horizontal and {p}_{0} belongs to CU with height >= 32 ) ) ? TRUE : FALSE$$

$$bSideQisLargeBlk = ( ( edge type is vertical and {p}_{0} belongs to CU with width >= 32 ) ‖ ( edge type is horizontal and {p}_{0} belongs to CU with height >= 32 ) ) ? TRUE : FALSE$$

Based on bSidePisLargeBlk and bSideQisLargeBlk, the condition 1 is defined as follows.

Condition1=(bSidePisLargeBlk∥bSidePisLargeBlk)?TRUE: FALSE

Next, if Condition 1 is true, the condition 2 will be further checked. First, the following variables are derived:
dp0, dp3, dq0, dq3 are first derived as in HEVC
if (p side is greater than or equal to 32)

$$dp 0 = ( dp 0 + Abs ( p {5}_{0} - 2 * p {4}_{0} + p {3}_{0} ) + 1 ) ≫ 1$$

$$dp 3 = ( dp 3 + Abs ( p {5}_{3} - 2 * p {4}_{3} + p {3}_{3} ) + 1 ) ≫ 1$$

if (q side is greater than or equal to 32)

$$dp 0 = ( dp 0 + Abs ( p {5}_{0} - 2 * p {4}_{0} + p {3}_{0} ) + 1 ) ≫ 1$$

$$dp 3 = ( dp 3 + Abs ( p {5}_{3} - 2 * p {4}_{3} + p {3}_{3} ) + 1 ) ≫ 1$$

$$Condition 2 = ( d < β ) ? TRUE : FALSE$$

$$where d = dp 0 + dq 0 + dp 3 + dq 3 .$$

If Condition1 and Condition2 are valid, whether any of the blocks uses sub-blocks is further checked:

```
If (bSidePisLargeBlk)
  {
    If (mode block P == SUBBLOCKMODE)
      Sp =5
    else
      Sp =7
}
else
  Sp = 3
If (bSideQisLargeBlk)
  {
    If (mode block Q == SUBBLOCKMODE)
        Sq =5
      else
        Sq =7
    }
else
  Sq = 3.
```

Finally, if both the Condition 1 and Condition 2 are valid, the proposed deblocking method will check the condition 3 (the large block strong filter condition), which is defined as follows.

In the Condition3 StrongFilterCondition, the following variables are derived:

```
  dpq is derived as in HEVC.
  sp₃ = Abs( p₃ − p₀ ), derived as in HEVC
  if (p side is greater than or equal to 32)
    if(Sp==5)
      sp₃ = ( sp₃ + Abs( p₅ − p₃ ) + 1) >> 1
    else
      sp₃ = ( sp₃ + Abs( p₇ − p₃ ) + 1) >> 1
  sq₃ = Abs( q₀ − q₃ ), derived as in HEVC
  if (q side is greater than or equal to 32)
    If(Sq==5)
    sq₃ = ( sq₃ + Abs( q₅ − q₃ ) + 1) >> 1
    else
    sq₃ = ( sq₃ + Abs( q₇ − q₃ ) + 1) >> 1.
    As in HEVC, StrongFilterCondition = (dpq is less than ( β >> 2 ),
sp₃ + sq₃ is less than ( 3*β >> 5 ), and Abs( p₀ − q₀ ) is less than ( 5 *
t_{C} + 1 ) >> 1) ? TRUE : FALSE.
```

### 2.4.4. Stronger Deblocking Filter for Luma (Designed for Larger Blocks)

Bilinear filter is used when samples at either one side of a boundary belong to a large block. A sample belonging to a large block is defined as when the width>=32 for a vertical edge, and when height>=32 for a horizontal edge.

The bilinear filter is listed below.

Block boundary samples pᵢ for i=0 to Sp−1 and qᵢ for j=0 to Sq−1 (pi and qi are the i-th sample within a row for filtering vertical edge, or the i-th sample within a column for filtering horizontal edge) in HEVC deblocking described above) are then replaced by linear interpolation as follows:

$${p}_{i}^{′} = ( {f}_{i} * {Middle}_{s , t} + ( 64 - {f}_{i} ) * {P}_{s} + 32 ) ≫ 6 ) , clipped to {p}_{i} \pm {tcPD}_{i}$$

$${q}_{j}^{′} = ( {g}_{j} * {Middle}_{s , t} + ( 64 - {g}_{j} ) * {Q}_{s} + 32 ) ≫ 6 ) , clipped to {q}_{j} \pm {tcPD}_{i}$$

where tcPDᵢ and tcPDⱼ term is a position dependent clipping described in Section 2.4.7 and gⱼ, fᵢ, Middle_{s,t}, Pₛ and Qₛ are given.

### 2.4.5. Deblocking Control for Chroma

The chroma strong filters are used on both sides of the block boundary. Here, the chroma filter is selected when both sides of the chroma edge are greater than or equal to 8 (chroma position), and the following decision with three conditions are satisfied: the first one is for decision of boundary strength as well as large block. The proposed filter can be applied when the block width or height which orthogonally crosses the block edge is equal to or larger than 8 in chroma sample domain. The second and third one is basically the same as for HEVC luma deblocking decision, which are on/off decision and strong filter decision, respectively.

In the first decision, boundary strength (bS) is modified for chroma filtering and the conditions are checked sequentially. If a condition is satisfied, then the remaining conditions with lower priorities are skipped.

Chroma deblocking is performed when bS is equal to 2, or bS is equal to 1 when a large block boundary is detected.

The second and third condition is basically the same as HEVC luma strong filter decision as follows.

In the second condition:
d is then derived as in HEVC luma deblocking.

The second condition will be TRUE when d is less than D.

In the third condition StrongFilterCondition is derived as follows:

```
  dpq is derived as in HEVC.
  sp₃ = Abs( p₃ − p₀ ), derived as in HEVC
  sq₃ = Abs( q₀ − q₃ ), derived as in HEVC
    As in HEVC design, StrongFilterCondition = (dpq is less than ( β >>
2 ), sp₃ + sq₃ is less than ( β >> 3 ), and Abs( p₀ − q₀ ) is less than ( 5 *
t_{C} + 1 ) >> 1)
```

### 2.4.6. Strong Deblocking Filter for Chroma

The following strong deblocking filter for chroma is defined:

$${p}_{2}^{′} = ( 3 * {p}_{3} + 2 * {p}_{2} + {p}_{1} + {p}_{0} + {q}_{0} + 4 ) ≫ 3$$

$${p}_{1}^{′} = ( 2 * {p}_{3} + {p}_{2} + 2 * {p}_{1} + {p}_{0} + {q}_{0} + {q}_{1} + 4 ) ≫ 3$$

$${p}_{0}^{′} = ( {p}_{3} + {p}_{2} + {p}_{1} + 2 * {p}_{0} + {q}_{0} + {q}_{1} + {q}_{2} + 4 ) ≫ 3.$$

The proposed chroma filter performs deblocking on a 4×4 chroma sample grid.

### 2.4.7. Position Dependent Clipping

The position dependent clipping tcPD is applied to the output samples of the luma filtering process involving strong and long filters that are modifying 7, 5 and 3 samples at the boundary. Assuming quantization error distribution, it is proposed to increase clipping value for samples which are expected to have higher quantization noise, thus expected to have higher deviation of the reconstructed sample value from the true sample value.

For each P or Q boundary filtered with asymmetrical filter, depending on the result of decision-making process in section 2.4.2, position dependent threshold table is selected from two tables (i.e., Tc7 and Tc3 tabulated below) that are provided to decoder as a side information:

$$Tc 7 = \{ 6 , 5 , 4 , 3 , 2 , 1 , 1 \} ; Tc 3 = \{ 6 , 4 , 2 \} ;$$

$$tcPD = ( Sp == 3 ) ? Tc 3 : Tc 7 ;$$

$$tcQD = ( Sp == 3 ) ? Tc 3 : Tc 7.$$

For the P or Q boundaries being filtered with a short symmetrical filter, position dependent threshold of lower magnitude is applied:

$$Tc 3 = \{ 3 , 2 , 1 \} .$$

Following defining the threshold, filtered p′ᵢ and q′ᵢ sample values are clipped according to tcP and tcQ clipping values:

$${p}_{i}^{″} = Clip 3 ( {p}_{i}^{′} + {tcP}_{i} , {p}_{i}^{′} - {tcP}_{i} , {p}_{i}^{′} ) ;$$

$${q}_{j}^{″} = Clip 3 ( {q}_{j}^{′} + {tcQ}_{j} , {q}_{j}^{′} - {tcQ}_{j} , {q}_{j}^{′} ) ;$$

where p′ᵢ and q′ᵢ are filtered sample values, p″ᵢ and q″ⱼ are output sample value after the clipping and tcPᵢ tcQᵢ are clipping thresholds that are derived from the VVC tc parameter and tcPD and tcQD. The function Clip3 is a clipping function as it is specified in VVC.

### 2.4.8. Sub-Block Deblocking Adjustment

To enable parallel friendly deblocking using both long filters and sub-block deblocking the long filters is restricted to modify at most 5 samples on a side that uses sub-block deblocking (AFFINE or ATMVP or DMVR) as shown in the luma control for long filters. Additionally, the sub-block deblocking is adjusted such that that sub-block boundaries on an 8×8 grid that are close to a CU or an implicit TU boundary is restricted to modify at most two samples on each side.

Following applies to sub-block boundaries that not are aligned with the CU boundary.

```
If (mode block Q == SUBBLOCKMODE && edge !=0) {
  if (!(implicitTU && (edge == (64 / 4))))
  if (edge == 2 || edge == (orthogonalLength − 2) || edge == (56 / 4) ||
  edge == (72 / 4))
    Sp = Sq = 2;
    else
    Sp = Sq = 3;
  else
    Sp = Sq = bSideQisLargeBlk ? 5:3
}
```

Where edge equal to 0 corresponds to CU boundary, edge equal to 2 or equal to orthogonalLength-2 corresponds to sub-block boundary 8 samples from a CU boundary etc. Where implicit TU is true if implicit split of TU is used.

### 2.5. SAO

The input of SAO is the reconstructed samples after DB. The concept of SAO is to reduce mean sample distortion of a region by first classifying the region samples into multiple categories with a selected classifier, obtaining an offset for each category, and then adding the offset to each sample of the category, where the classifier index and the offsets of the region are coded in the bitstream. In HEVC and VVC, the region (the unit for SAO parameters signaling) is defined to be a CTU.

Two SAO types that can satisfy the requirements of low complexity are adopted in HEVC. Those two types are edge offset (EO) and band offset (BO), which are discussed in further detail below. An index of an SAO type is coded (which is in the range of [0, 2]). For EO, the sample classification is based on comparison between current samples and neighboring samples according to 1-D directional patterns: horizontal, vertical, 1350 diagonal, and 450 diagonal.

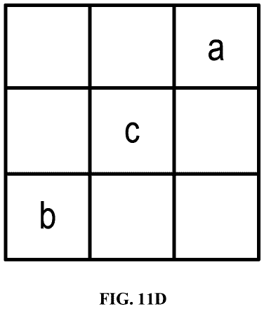

FIGS. 11A-11D illustrate example diagrams showing four 1-D directional patterns for EO sample classification, where horizontal (EO class=0), vertical (EO class=1), 135° diagonal (EO class=2), and 45° diagonal (EO class=3).

For a given EO class, each sample inside the CTB is classified into one of five categories. The current sample value, labeled as “c,” is compared with its two neighbors along the selected 1-D pattern. The classification rules for each sample are summarized in Table I. Categories 1 and 4 are associated with a local valley and a local peak along the selected 1-D pattern, respectively. Categories 2 and 3 are associated with concave and convex corners along the selected 1-D pattern, respectively. If the current sample does not belong to EO categories 1-4, then it is category 0 and SAO is not applied.

TABLE 3
Sample Classification Rules for Edge Offset

| Category | Condition |
|---|---|
| 1 | c < a and c < b |
| 2 | (c < a && c == b) ∥(c == a && c < b) |
| 3 | (c > a && c == b) ∥(c == a && c > b) |
| 4 | c > a && c > b |
| 5 | None of above |

### 2.6. Geometry Transformation-Based Adaptive Loop Filter in JEM

The input of DB is the reconstructed samples after DB and SAO. The sample classification and filtering process are based on the reconstructed samples after DB and SAO.

In the JEM, a geometry transformation-based adaptive loop filter (GALF) with block-based filter adaption is applied. For the luma component, one among 25 filters is selected for each 2×2 block, based on the direction and activity of local gradients.

### 2.6.1. Filter Shape

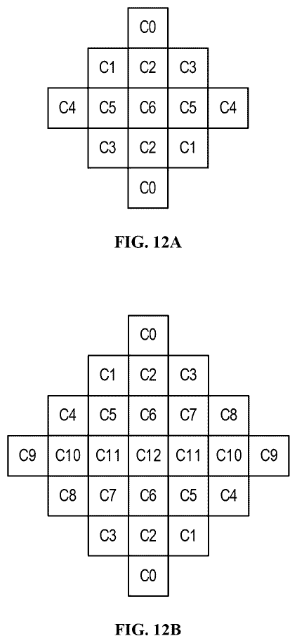

In the JEM, up to three diamond filter shapes (as shown in FIG. 12A to FIG. 12C) can be selected for the luma component. An index is signalled at the picture level to indicate the filter shape used for the luma component. Each square represents a sample, and Ci (i being 0˜6 (left), 0˜12 (middle), 0˜20 (right)) denotes the coefficient to be applied to the sample. For chroma components in a picture, the 5×5 diamond shape is always used.

FIG. 12A to FIG. 12C shows examples of the GALF filter shapes (FIG. 12A: 5×5 diamond, FIG. 12B: 7×7 diamond, FIG. 12C: 9×9 diamond).

### 2.6.1.1. Block Classification

Each 2×2 block is categorized into one out of 25 classes. The classification index C is derived based on its directionality D and a quantized value of activity Â, as follows:

$$C = 5 D + Â . \qquad ( 1 )$$

To calculate D and Â, gradients of the horizontal, vertical and two diagonal direction are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert , \qquad ( 2 )$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert , \qquad ( 3 )$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert \qquad ( 4 )$$

$$( 5 )$$

$${g}_{d 2} = {\sum }_{k = i - 2}^{i + 3} {\sum }_{j = j - 2}^{j + 3} D {2}_{k , l} , {D2}_{k , l} = \vert 2 R ( k , l ) - R ( k - 1 , l + 1 ) - R ( k + 1 , l - 1 ) \vert .$$

Indices i and j refer to the coordinates of the upper left sample in the 2×2 block and R(i, j) indicates a reconstructed sample at coordinate (i, j).

Then D maximum and minimum values of the gradients of horizontal and vertical directions are set as:

$$\begin{matrix}{g}_{h , v}^{max} = max ( {g}_{h} , {g}_{v} ) , & {g}_{h , v}^{min} = min ( {g}_{h} , {g}_{ν} ) ,\end{matrix} \qquad ( 6 )$$

and the maximum and minimum values of the gradient of two diagonal directions are set as:

$${g}_{d 0 , d 1}^{max} = max ( {g}_{d 0} , {g}_{d 1} ) , {g}_{d 0 , d 1}^{min} = min ( {g}_{d 0} , {g}_{d 1} ) . \qquad ( 7 )$$

To derive the value of the directionality D, these values are compared against each other and with two thresholds t₁ and t₂:
Step 1. If both

$${g}_{h , v}^{max} \leq {t}_{1} \cdot {g}_{h , v}^{min} and {g}_{d0 , d 1}^{max} \leq {t}_{1} \cdot {g}_{d0 , d 1}^{min}$$

are true, D is set to 0.
Step 2. If

$${g}_{h , v}^{max} / {g}_{h , v}^{min} > {g}_{d 0 , d 1}^{max} / {g}_{d 0 , d 1}^{min} ,$$

continue from Step 3; otherwise continue from Step 4.
Step 3. If

$${g}_{h , v}^{max} > {t}_{2} \cdot {g}_{h , v}^{min} ,$$

D is set to 2; otherwise D is set to 1.
Step 4. If

$${g}_{d 0 , d 1}^{max} > {t}_{2} \cdot {g}_{d 0 , d 1}^{min} ,$$

D is set to 4; otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} ) . \qquad ( 8 )$$

A is further quantized to the range of 0 to 4, inclusively, and the quantized value is denoted as Â.

For both chroma components in a picture, no classification method is applied, i.e. a single set of ALF coefficients is applied for each chroma component.

### 2.6.1.2. Geometric Transformations of Filter Coefficients

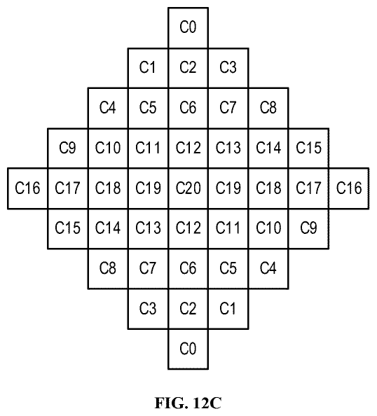

FIG. 13A to FIG. 13C illustrate example diagrams showing examples of relative coordinator for the 5×5 diamond filter support.

Before filtering each 2×2 block, geometric transformations such as rotation or diagonal and vertical flipping are applied to the filter coefficients f (k, l), which is associated with the coordinate (k, l), depending on gradient values calculated for that block. This is equivalent to applying these transformations to the samples in the filter support region. The idea is to make different blocks to which ALF is applied more similar by aligning their directionality.

Three geometric transformations, including diagonal, vertical flip and rotation are introduced:

$$\begin{matrix}Diagonal : {f}_{D} ( k , l ) = f ( l , k ) , \\ Vertical flip : {f}_{V} ( k , l ) = f ( k , K - l - 1 ) , \\ Rotation : {f}_{R} ( k , l ) = f ( K - l - 1 , k ) .\end{matrix} \qquad ( 9 )$$

where K is the size of the filter and 0≤k, l≤K−1 are coefficients coordinates, such that location (0,0) is at the upper left corner and location (K−1, K−1) is at the lower right corner. The transformations are applied to the filter coefficients f (k, l) depending on gradient values calculated for that block. The relationship between the transformation and the four gradients of the four directions are summarized in Table 4. FIG. 12 shows the transformed coefficients for each position based on the 5×5 diamond.

TABLE 4
Mapping of the gradient calculated for
one block and the transformations

| Gradient values | Transformation |
|---|---|
| g_{d2} < g_{d1} and gₕ < gᵥ | No transformation |
| g_{d2} < g_{d1} and gᵥ < gₕ | Diagonal |
| g_{d1} < g_{d2} and gₕ < gᵥ | Vertical flip |
| g_{d1} < g_{d2} and gᵥ < gₕ | Rotation |

### 2.6.1.3. Filter Parameters Signalling

In the JEM, GALF filter parameters are signalled for the first CTU, i.e., after the slice header and before the SAO parameters of the first CTU. Up to 25 sets of luma filter coefficients could be signalled. To reduce bits overhead, filter coefficients of different classification can be merged. Also, the GALF coefficients of reference pictures are stored and allowed to be reused as GALF coefficients of a current picture. The current picture may choose to use GALF coefficients stored for the reference pictures and bypass the GALF coefficients signalling. In this case, only an index to one of the reference pictures is signalled, and the stored GALF coefficients of the indicated reference picture are inherited for the current picture.

To support GALF temporal prediction, a candidate list of GALF filter sets is maintained. At the beginning of decoding a new sequence, the candidate list is empty. After decoding one picture, the corresponding set of filters may be added to the candidate list. Once the size of the candidate list reaches the maximum allowed value (i.e., 6 in current JEM), a new set of filters overwrites the oldest set in decoding order, and that is, first-in-first-out (FIFO) rule is applied to update the candidate list. To avoid duplications, a set could only be added to the list when the corresponding picture doesn't use GALF temporal prediction. To support temporal scalability, there are multiple candidate lists of filter sets, and each candidate list is associated with a temporal layer. More specifically, each array assigned by temporal layer index (TempIdx) may compose filter sets of previously decoded pictures with equal to lower TempIdx. For example, the k-th array is assigned to be associated with TempIdx equal to k, and it only contains filter sets from pictures with TempIdx smaller than or equal to k. After coding a certain picture, the filter sets associated with the picture will be used to update those arrays associated with equal or higher TempIdx.

Temporal prediction of GALF coefficients is used for inter coded frames to minimize signalling overhead. For intra frames, temporal prediction is not available, and a set of 16 fixed filters is assigned to each class. To indicate the usage of the fixed filter, a flag for each class is signalled and if required, the index of the chosen fixed filter. Even when the fixed filter is selected for a given class, the coefficients of the adaptive filter f(k, l) can still be sent for this class in which case the coefficients of the filter which will be applied to the reconstructed image are sum of both sets of coefficients.

The filtering process of luma component can controlled at CU level. A flag is signalled to indicate whether GALF is applied to the luma component of a CU. For chroma component, whether GALF is applied or not is indicated at picture level only.

### 2.6.1.4. Filtering Process

At decoder side, when GALF is enabled for a block, each sample R(i,j) within the block is filtered, resulting in sample value R′(i, j) as shown below, where L denotes filter length, f_{m,n} represents filter coefficient, and f (k, l) denotes the decoded filter coefficients.

$${R}^{′} ( i , j ) = {\sum }_{k = - L / 2}^{L / 2} {\sum }_{l = - L / 2}^{L / 2} f ( k , l ) \times R ( i + k , j + l ) \qquad ( 10 )$$

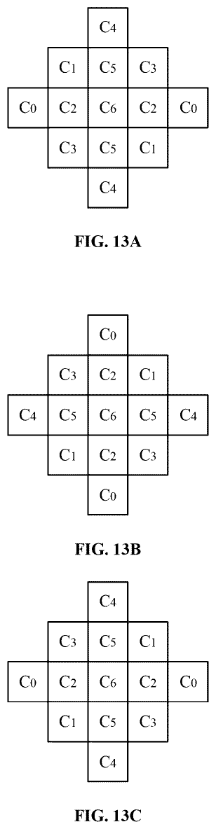

FIG. 14 shows an example of relative coordinates used for 5×5 diamond filter support supposing the current sample's coordinate (i, j) to be (0, 0). Samples in different coordinates filled with the same color are multiplied with the same filter coefficients.

### 2.7. Geometry Transformation-Based Adaptive Loop Filter (GALF) in VVC

### 2.7.1. GALF in VTM-4

In VTM4.0, the filtering process of the Adaptive Loop Filter, is performed as follows:

$$O ( x , y ) = {\sum }_{( i , j )} w ( i , j ) \cdot I ( x + i , y + j ) , \qquad ( 11 )$$

where samples I(x+i, y+j) are input samples, O(x, y) is the filtered output sample (i.e. filter result), and w(i,j) denotes the filter coefficients. In practice, in VTM4.0 it is implemented using integer arithmetic for fixed point precision computations:

$$O ( x , y ) = ( {\sum }_{i = - \frac{L}{2}}^{\frac{L}{2}} {\sum }_{j = - \frac{L}{2}}^{\frac{L}{2}} w ( i , j ) \cdot I ( x + i , y + j ) + 64 ) ≫ 7 , \qquad ( 12 )$$

where L denotes the filter length, and where w(i, j) are the filter coefficients in fixed point precision.

The current design of GALF in VVC has the following major changes compared to that in JEM:
1) The adaptive filter shape is removed. Only 7×7 filter shape is allowed for luma component and 5×5 filter shape is allowed for chroma component.
2) Signaling of ALF parameters in removed from slice/picture level to CTU level.
3) Calculation of class index is performed in 4×4 level instead of 2×2. In addition, as proposed in JVET-L0147, sub-sampled Laplacian calculation method for ALF classification is utilized. More specifically, there is no need to calculate the horizontal/vertical/45 diagonal/135 degree gradients for each sample within one block. Instead, 1:2 subsampling is utilized.

### 2.8. Non-Linear ALF in Current VVC

### 2.8.1. Filtering Reformulation

Equation (11) can be reformulated, without coding efficiency impact, in the following expression:

$$O ( x , y ) = I ( x , y ) + {\sum }_{( i , j ) \neq ( 0 , 0 )} w ( i , j ) \cdot ( I ( x + i , y + j ) - I ( x , y ) ) , \qquad ( 13 )$$

where w(i,j) are the same filter coefficients as in equation (11) [excepted w(0, 0) which is equal to 1 in equation (13) while it is equal to 1−Σ_{(i,j)≠(0,0)} w(i, j) in equation (11)].

Using this above filter formula of (13), VVC introduces the non-linearity to make ALF more efficient by using a simple clipping function to reduce the impact of neighbor sample values (I(x+i, y+j)) when they are too different with the current sample value (I(x, y)) being filtered.

More specifically, the ALF filter is modified as follows:

$${O}^{′} ( x , y ) = I ( x , y ) + {\sum }_{( i , j ) \neq ( 0 , 0 )} w ( i , j ) \cdot K ( I ( x + i , y + j ) - I ( x , y ) , k ( i , j ) ) , \qquad ( 14 )$$

where K(d, b)=min(b, max(−b, d)) is the clipping function, and k(i,j) are clipping parameters, which depends on the (i, j) filter coefficient. The encoder performs the optimization to find the best k(i, j).

In the JVET-N0242 implementation, the clipping parameters k(i, j) are specified for each ALF filter, one clipping value is signaled per filter coefficient. It means that up to 12 clipping values can be signalled in the bitstream per Luma filter and up to 6 clipping values for the Chroma filter.

In order to limit the signaling cost and the encoder complexity, only 4 fixed values which are the same for INTER and INTRA slices are used.

Because the variance of the local differences is often higher for Luma than for Chroma, two different sets for the Luma and Chroma filters are applied. The maximum sample value (here 1024 for 10 bits bit-depth) in each set is also introduced, so that clipping can be disabled if it is not necessary.

The sets of clipping values used in the JVET-N0242 tests are provided in the Table 5. The 4 values have been selected by roughly equally splitting, in the logarithmic domain, the full range of the sample values (coded on 10 bits) for Luma, and the range from 4 to 1024 for Chroma.

More precisely, the Luma table of clipping values have been obtained by the following formula:

$${AlfClip}_{L} = \{ round ( {( {( M )}^{\frac{1}{N}} )}^{N - n + 1} ) for n ∈ 1 . . N ] \} , with M = {2}^{10} and N = 4 . \qquad ( 15 )$$

Similarly, the Chroma tables of clipping values is obtained according to the following formula:

$${AlfClip}_{C} = \{ round ( A . {( {( \frac{M}{A} )}^{\frac{1}{N - 1}} )}^{N - n} ) for n ∈ 1 . . N ] \} , with M = {2}^{10} , N = 4 and A = 4 . \qquad ( 16 )$$

TABLE 5
Authorized clipping values

| | INTRA/INTER tile group |
|---|---|
| LUMA | {1024, 181, 32, 6} |
| CHROMA | {1024, 161, 25, 4} |

The selected clipping values are coded in the “alf_data” syntax element by using a Golomb encoding scheme corresponding to the index of the clipping value in the above Table 5. This encoding scheme is the same as the encoding scheme for the filter index.

### 2.9. Convolutional Neural Network-Based Loop Filters for Video Coding

### 2.9.1. Convolutional Neural Networks

In deep learning, a convolutional neural network (CNN, or ConvNet) is a class of deep neural networks, most commonly applied to analyzing visual imagery. They have very successful applications in image and video recognition/processing, recommender systems, image classification, medical image analysis, natural language processing.

CNNs are regularized versions of multilayer perceptrons. Multilayer perceptrons usually mean fully connected networks, that is, each neuron in one layer is connected to all neurons in the next layer. The “fully-connectedness” of these networks makes them prone to overfitting data. Typical ways of regularization include adding some form of magnitude measurement of weights to the loss function. CNNs take a different approach towards regularization: they take advantage of the hierarchical pattern in data and assemble more complex patterns using smaller and simpler patterns. Therefore, on the scale of connectedness and complexity, CNNs are on the lower extreme.

CNNs use relatively little pre-processing compared to other image classification/processing algorithms. This means that the network learns the filters that in traditional algorithms were hand-engineered. This independence from prior knowledge and human effort in feature design is a major advantage.

### 2.9.2. Deep Learning for Image/Video Coding

Deep learning-based image/video compression typically has two implications: end-to-end compression purely based on neural networks and traditional frameworks enhanced by neural networks. The first type usually takes an auto-encoder like structure, either achieved by convolutional neural networks or recurrent neural networks. While purely relying on neural networks for image/video compression can avoid any manual optimizations or hand-crafted designs, compression efficiency may be not satisfactory. Therefore, works distributed in the second type take neural networks as an auxiliary, and enhance traditional compression frameworks by replacing or enhancing some modules. In this way, they can inherit the merits of the highly optimized traditional frameworks. For example, a fully connected network for the intra prediction in HEVC has been proposed. In addition to intra prediction, deep learning is also exploited to enhance other modules. For example, the early work replaces the in-loop filters of HEVC with a convolutional neural network and achieve promising results. The early work applies neural networks to improve the arithmetic coding engine.

2.9.3. Convolutional Neural Network Based in-Loop Filtering

In lossy image/video compression, the reconstructed frame is an approximation of the original frame, since the quantization process is not invertible and thus incurs distortion to the reconstructed frame. To alleviate such distortion, a convolutional neural network could be trained to learn the mapping from the distorted frame to the original frame. In practice, training must be performed prior to deploying the CNN-based in-loop filtering.

### 2.9.3.1. Training

The purpose of the training processing is to find the optimal value of parameters including weights and bias.

First, a codec (e.g. HM, JEM, VTM, etc.) is used to compress the training dataset to generate the distorted reconstruction frames.

Then the reconstructed frames are fed into the CNN and the cost is calculated using the output of CNN and the groundtruth frames (original frames). Commonly used cost functions include SAD (Sum of Absolution Difference) and MSE (Mean Square Error). Next, the gradient of the cost with respect to each parameter is derived through the back propagation algorithm. With the gradients, the values of the parameters can be updated. The above process repeats until the convergence criteria is met. After completing the training, the derived optimal parameters are saved for use in the inference stage.

### 2.9.3.2. Convolution Process

During convolution, the filter is moved across the image from left to right, top to bottom, with a one-pixel column change on the horizontal movements, then a one-pixel row change on the vertical movements. The amount of movement between applications of the filter to the input image is referred to as the stride, and it is almost always symmetrical in height and width dimensions. The default stride or strides in two dimensions is (1,1) for the height and the width movement.

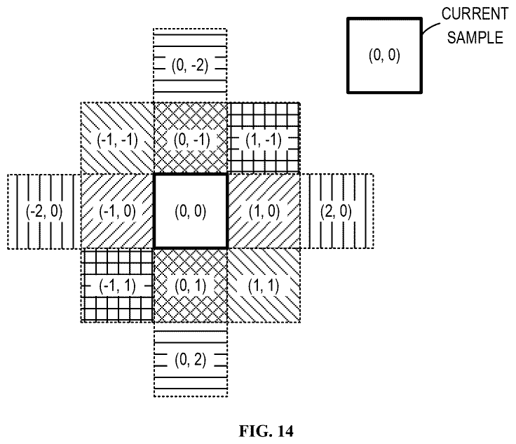

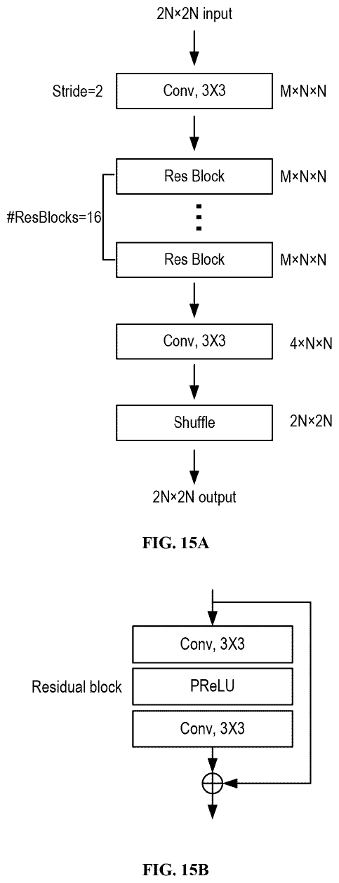

In most of deep convolutional neural networks, residual blocks are utilized as the basic module and stacked several times to construct the final network wherein in one example, the residual block is obtained by combining a convolutional layer, a ReLU/PReLU activation function and a convolutional layer as shown in FIG. 15B.

FIG. 15A shows an architecture of the proposed CNN filter, where M denotes the number of feature maps, and N stands for the number of samples in one dimension. FIG. 15B show the construction of ResBlock (residual block) in FIG. 15A.

### 2.9.3.3. Inference

During the inference stage, the distorted reconstruction frames are fed into CNN and processed by the CNN model whose parameters are already determined in the training stage. The input samples to the CNN can be reconstructed samples before or after DB, or reconstructed samples before or after SAO, or reconstructed samples before or after ALF.

### 3. Problems

The current NN-based loop filtering has the following problems:
1. The same convolutions are used for each input of NN-based loop filter. However, different inputs may have different importance. Therefore, it is reasonable to assign different convolutions with different kernel size and channel numbers for each input.
2. The convolution with kernel size KK is widely used in NN-based loop filter. However, it can be decomposed into combinations of several convolutions with smaller kernel size to reduce the complexity.
3. Side information generated during compression may be used as extra input to improve the performance of NN-based loop filter. For example, prediction picture, slice type, boundary strength, base QP, slice QP, and IPB information could be used as side information.
4. Multi-scale structure for neural network may be beneficial for improving the performance of NN-based loop filter.
5. The NN-based network is used for designing loop filter. However, non-adjacent information is not considered. The Transformer based network could capture global information.
6. The NN-based filter is proposed to enhance reconstruction. However, the traditional filter may exceed the NN-based filter for some video content. So it is reasonable to combine the traditional filter and NN filter.
7. The parameters of NN-based filter are fixed in the training process. However, the parameter such as QP, inference size, block extension size should adapt to the various video content in the inference process.
8. The NN-based loop filter may be used for luma component, chroma component, or both luma and chroma components.
9. The NN-based loop filter may be used for intra slice, inter slice, or both intra and inter slices.

### 4. Detailed Solutions

The detailed solutions below should be considered as examples to explain general concepts. These solutions should not be interpreted in a narrow way. Furthermore, these solutions can be combined in any manner.

One or more neural network (NN) filter models are trained as part of an in-loop filtering technology or filtering technology used in a post-processing stage for reducing the distortion incurred during compression. Samples with different characteristics are processed by different NN filter models. The present disclosure elaborates how to design a unified NN filter model by feeding at least one indicator which may be related to the quality level (e.g. QP or Constant rate factor (CRF) value or bitrates)/slice type/coding modes/coded information as the input of NN filter.

It should be noted that the concept of unifying NN model by feeding the indicator as the input of NN process could be also extended to other NN-based coding tools, such as NN-based intra prediction, NN-based cross component prediction, NN-based inter prediction, NN-based super-resolution, NN-based motion compensation, NN-based transform design. In the examples below, we use NN-based filtering technology as an example.

It should also be noted that the concept of feeding the coded information as the input of NN process could be also extended to non-NN-based coding tools, such as non-NN-based intra prediction, non-NN-based cross component prediction, non-NN-based inter prediction, non-NN-based super-resolution, non-NN-based motion compensation, non-NN-based transform design. For example, a non-NN based coding tool may classify the to-be-filtered samples into different categories using the coded information.

In the disclosure, a NN filter can be any kind of NN filter, such as a convolutional neural network (CNN) filter, fully connected neural network filter, transformer-based filter, recurrent neural network-based filter.

In the following discussion, a video unit may be a sequence, a picture, a slice, a tile, a brick, a subpicture, a CTU/CTB, a CTU/CTB row, one or multiple CUs/CBs, one ore multiple CTUs/CTBs, one or multiple VPDU (Virtual Pipeline Data Unit), a sub-region within a picture/slice/tile/brick. A father video unit represents a unit larger than the video unit. Typically, a father unit will contain several video units. E.g., when the video unit is CTU, the father unit could be slice, CTU row, multiple CTUs, etc.

To simplify the NN filter by adaptive channel number
1. To solve problem 1, different convolution types are assigned to different inputs.
   a. In one example, the convolution shares the same convolution kernel size and different channel numbers may be assigned for each input.
      i. In one example, the channel numbers for each input are denoted as C₁, C₂, . . . , Cₙ where n is an integer which denotes the number of inputs.
         1) In one example, furthermore, one constraint is added that for any indexes i and j where 1≤i, j≤n that Cᵢ≠Cⱼ.
         2) In one example, furthermore, one constraint is added that there is at least one pair of indexes i and j where 1≤i, j≤n that Cᵢ≠Cⱼ.
   b. In one example, the convolution shares the same convolution channel numbers and different convolution kernel size are assigned for each input.
      i. In one example, 1×1 kernel size may be used for the convolution of partial input and K×K kernel size is used for the convolution of the rest input. The K denotes an integer value greater than 1.
   c. In one example, different convolution channel numbers and different convolution kernel size are assigned for each input.

### To Simplify the NN Filter by Decomposition

2. To solve problem 2, the C₁×C₂×K×K convolution may be decomposed into a combination of several convolutions with smaller kernel size. The K denotes an integer value greater than 1, C₁ and C₂ denote the input channel number and output channel number of the convolution, respectively.
   a. In one example, the input and output channel number of the convolution may be not changed when it is decomposed.
      i. In one example, the C₁×C₂×K×K convolution is decomposed into a combination of C₁×C₂×1×K convolution followed by C₁×C₂×K×1 convolution.
      ii. In one example, the C₁×C₂×K×K convolution is decomposed into a combination of C₁×C₂×1×K convolution followed by C₁×C₂×K×1 convolution and any activation layer may be placed after each convolution.
      iii. In one example, the C₁×C₂×K×K convolution is decomposed into a combination of C₁×C₂×K×1 convolution followed by C₁×C₂×1×K convolution.
      iv. In one example, the C₁×C₂×K×K convolution is decomposed into a combination of C₁×C₂×K×1 convolution followed by C₁×C₂×1×K convolution and any activation layer may be placed after each convolution.
   b. In one example, the input and output channel number of the convolution may be changed when it is decomposed.
      i. In one example, the C₁×C₂×K×K convolution is decomposed into a combination of C₁×C₃×1×K convolution followed by C₃×C₂×K×1 convolution, where C₃ is a positive integer different with C₂.
      ii. In one example, the C₁×C₂×K×K convolution is decomposed into a combination of C₁×C₃×1×K convolution followed by C₃×C₂×K×1 convolution and any activation layer may be placed after each convolution, where C₃ is a positive integer different with C₂.
      iii. In one example, the C₁×C₂×K×K convolution is decomposed into a combination of C₁×C₃×K×1 convolution followed by C₃×C₂×1×K convolution, where C₃ is a positive integer different with C₂.
      iv. In one example, the C₁×C₂×K×K convolution is decomposed into a combination of C₁×C₃×K×1 convolution followed by C₃×C₂×1×K convolution and any activation layer may be placed after each convolution, where C₃ is a positive integer different with C₂.
   c. In one example, partial K×K convolutions are decomposed.
   d. In one example, all the K×K convolutions are decomposed.

### To Design Side Information of NN Filter

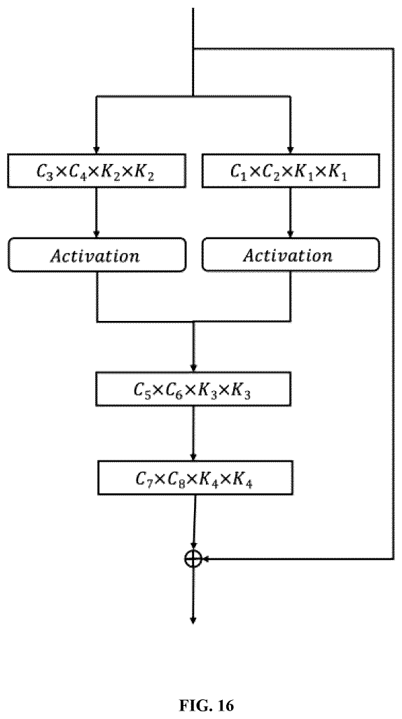

3. To solve problem 3, which side information to be used as extra input of NN-based loop filter and how they are processed is specified.
   a. In one example, the side information may be used as extra input of NN-based loop filter.
      i. In one example, the slice QP may be used as extra input of NN-based loop filter.
         1) In one example, furthermore, the slice QP is normalized by sliceQP÷MAX_QP where the value of MAX_QP may be 63.
         2) In one example, furthermore, the slice QP is first tiled or spanned into a 2-dimensional arrays with the same size as the video unit to be filtered.
      ii. In one example, the base QP may be used as extra input of NN-based loop filter.
         1) In one example, furthermore, the base QP is normalized by baseQP÷MAX_QP where the value of MAX_QP may be 63.
         2) In one example, furthermore, the base QP is first tiled or spanned into a 2-dimensional arrays with the same size as the video unit to be filtered.
      iii. In one example, the prediction picture may be used as extra input of NN-based loop filter.
      iv. In one example, the slice type may be used as extra input of NN-based loop filter.
         1) In one example, furthermore, the slice type may be a binary value which indicates whether the picture to be filtered is intra slice.
         2) In one example, the slice type indicator is first tiled or spanned into a 2-dimensional arrays with the same size as the video unit to be filtered.
      v. In one example, the IPB information of the video unit to be filtered may be used as extra input of NN-based loop filter.
         1) In one example, furthermore, the IPB information may be derived from the slice type.
         a) In one example, the value of IPB information is derived as follows, it is equal to a if slice type is I slice, or it is equal to b if slice type is B slice, or it is equal to c if slice type is P slice, where a, b, and c are constants.
         i. In one example, b=c.
         ii. In one example, b=−a, c=−a.
         iii. In one example, a=1, b=−1, c=−1.
         iv. In one example, a=1, b=0.5, c=0.5.
         2) In one example, the IPB information is first tiled or spanned into a 2-dimensional arrays with the same size as the video unit to be filtered.
      vi. In one example, the boundary strength of the video unit to be filtered may be used as extra input of NN-based loop filter.
      vii. In one example, any combination of above side information may be used as extra input of NN-based loop filter.
   b. In one example, convolutions for each input side information are performed separately and then all the convolution results are concatenated with the output of convolution of reconstruction picture.
   c. In one example, the reconstruction picture and side information are concatenated and followed by a convolution.
4. To solve problem 4, muti-scale neural network structure may be used in the NN-based loop filter.
   a. In one example, neural network with two branches may be used and one possible solution is presented as illustrated in FIG. 16. In FIG. 16, K₁ denotes the kernel size where 1≤i≤4, _{C} is related to the channel numbers, where 1≤j≤8.
      i. In one example, further more, the convolution with kernel size K×K may be decomposed into several convolutions with smaller kernel size, which is a combination with bullets 2.
      ii. In one example, the activation layers may be used.
         1) In one example, furthermore, the activation layers may be used after all the convolution layers.
         2) In one example, furthermore, the activation layers may be used after partial the convolution layers.
         3) In one example, the activation layers might be PRelu layer.
         4) In one example, the activation layers might be Relu layer.
      iii. In one example, the residual connection may be used.
   b. In one example, neural network with multiple branches may be used. In each branch, different convolution with different kernel size, channel number, or stride might be used.
      i. In one example, furthermore, the convolution with kernel size K×K may be decomposed into several convolutions with smaller kernel size, which is a combination with invention 2.
      ii. In one example, the activation layers may be used.
         1) In one example, furthermore, the activation layers may be used after the activation layers may be used after all the convolution layers.
         2) In one example, furthermore, the activation layers may be used after the activation layers may be used after partial the convolution layers.
         3) In one example, the activation layers might be PRelu layer.
         4) In one example, the activation layers might be Relu layer.
      iii. In one example, the residual connection may be used.
   c. In one example, this muti-scale neural network structure may be used as basic block in the whole NN-based loop filter.
      i. In one example, this basic block may be used N times where N is an integer greater than 0.
      ii. In one example, this basic block may be used together with other kinds of blocks.
         1) In one example, this basic block may be used together with other convolution layers and activation layers.
         2) In one example, this basic block may be used together with residual blocks.

### To Design Transformer Based NN Filter

5. To solve problem 5, it is proposed that Transformer-based structure may be involved in the design of the NN filter.
   a. In one example, the head/backbone/tail may be designed by using Transformer network.
6. To solve problem 5, it is proposed that Transformer-based structure may be combined with CNN in the design of the NN filter.
   a. In one example, CNN module may be followed by Transformer module in the network of NN filter.
7. To solve problem 5, it is proposed that transformer-based structure and CNN-based structure may be alternative in the design of the NN filter.
   a. In one example, the NN filters may be selected when there are two NN-based filters which contain one CNN-based filter and one transformer-based filter.
      To Combine NN Filter with DBF/SAO
8. To solve problem 6, it is proposed that the NN filter may be combined/fused/blended with traditional filters.
   a. In one example, traditional filters may be Deblocking filter (DBF).
   b. In one example, traditional filters may be Sample Adaptive Offset (SAO).
   c. In one example, traditional filters may be the combination of DBF and SAO.
   d. In one example, the NN filter and DBF may be fused/blended.
      i. In one example, SAO may be after the fusing/blending of NN filter and DBF filter.
         1) In one example, SAO may be enabled/disabled by the syntax element in the SPS/PPS, etc.
      ii. In one example, ALF may be used after SAO.
         1) In one example, ALF may be enabled/disabled by the syntax element in the SPS/PPS, etc.
      e. In one example, the NN filter and the combination of DBF and SAO may be fused/blended.
      i. In one example, Adaptive Loop Filter (ALF) may be used after the fusing/blending of NN filter and the combination of DBF and SAO.
         1) In one example, ALF may be enabled/disabled by the syntax element in the SPS/PPS, etc.

### To Design Scaling Factor

9. To solve problem 6, it is proposed that the reconstruction samples of traditional filter and NN filter are fused/blended by a scaling factor.
   a. In one example, reconstruction samples may be fused/blended in slice/block level.
   b. In one example, the scaling factor may be adaptive which can be determined by video content.
   c. In one example, the scaling factor may be pre-defined.
   d. In one example, the scaling factor may be separated for different components.
      i. In one example, the scaling factor may be separated for luma and chroma components.
      ii. In one example, the scaling factor may be separated for U and V components.

### To Design QP Adjustment, Parameter Number, Block QP Adaptation

10. To solve problem 7, it is proposed that there is a candidate list which contains multiple input parameters.
   a. In one example, the number of candidates in the list may be configurable in sequence/slice/block level.
   b. In one example, the candidate list may be constructed in sequence/slice/block level.
   c. In one example, the candidate list may be adaptive for sequence/slice/block level.
   d. In one example, the input parameter is a variable dependent on base QP which denoted as q.
      i. In one example, q is QP in sequence/slice/block level.
   e. In one example, the candidate list may include the base QP and adjusted QP.
      i. In one example, adjusted QP may be equal to the base QP q by adding an offset.
      ii. In one example, offset may be equal to −5, 10, 5.
      iii. In one example, offset may be dependent on the TID level.

### To Design Adaptive Inference Granularity/Configurable Inference Size

11. To solve problem 7, it is proposed that the inference granularity/size of NN filter may be adaptive for the sequence/slice/block level.
   a. In one example, the granularity/size may be dependent on the slice type.
   b. In one example, the granularity/size may be configurable which dependent on the syntax element in the sequence/slice/block level.

### To Design Block Extension Size

12. To solve problem 7, it is proposed that the block extension/padding size may be adaptive for the sequence/slice/block level.
   a. In one example, the block extension/padding size may be dependent on the block modes and/or slice type.
   b. In one example, the block extension/padding size may be configurable which dependent on the syntax element in the sequence/slice/block level.

### To the Usage of Unified NN Filter

13. To solve problem 8, the output of NN-based filter may be luma components, chroma components, or both luma and chroma components.
   a. In one example, separate NN-based filters may be used for generating outputs of luma components and outputs of chroma components, respectively.
      i. In one example, furthermore, a total number of M₁ models may be used for generating output of luma components, and a total number of M₂ models may be used for generating outputs of chroma components, where both M₁ and M₂ are integers greater than 0.
         1) In one example, furthermore, the Cb and Cr components may share the same chroma model of NN-based filter.
   b. In one example, a single NN-based filters may be used for generating outputs of luma components and outputs of chroma components.
      i. In one example, furthermore, a total number of M₁ models may be used, and for each model, the outputs of luma components and chroma components may be generated, where M₁ is an integer greater than 0.
      ii. In one example, furthermore, the output luma and chroma components generated by the single NN-based filter may be used together.
      iii. In one example, furthermore, the output luma and chroma components generated by the single NN-based filter may be used separately.
         1) In one example, furthermore, the output luma component generated by the single NN-based filter may be used and the output chroma component generated by the single NN-based filter may be NOT used.
         2) In one example, furthermore, the output luma component generated by the single NN-based filter may be NOT used and the output chroma component generated by the single NN-based filter may be used.
14. To solve problem 9, a single NN-based filters may be used for generating filtered outputs for both intra and inter slices.
   a. In one example, intra slice may refer to I slice.
      In one example, inter slice may refer to B slice or P slice or B and P slices.

### To Design Unified NN Filter

15. It is proposed that a unified NN filter is designed by the all or part of mentioned items which should not be interpreted in a narrow way.

### 5. Embodiments

### 5.1. Embodiment 1

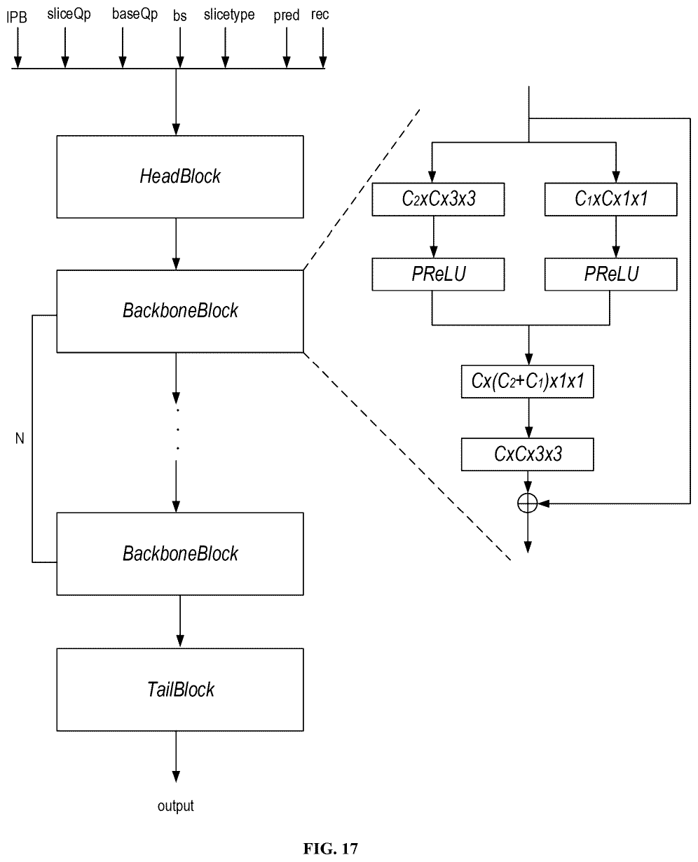

FIG. 17 shows a first example network structure of NN filter which include Item 3 side information, Item 4 muti-scale NN structure.

### 5.2. Embodiment 2

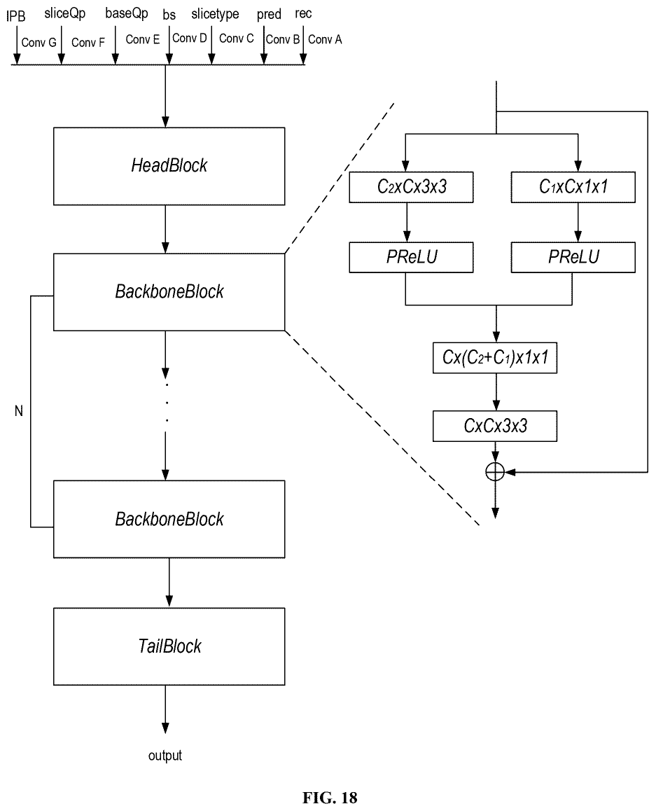

FIG. 18 shows a second example network structure of NN filter which include Item 1 adaptive channel number, Item 3 side information, Item 4 muti-scale NN structure. The Conv A, Conv B, . . . , Conv G are convolutions with different channel numbers. The larger text font means larger channel numbers, for example, the Conv A is convolution with the largest channel number.

### 5.3. Embodiment 3

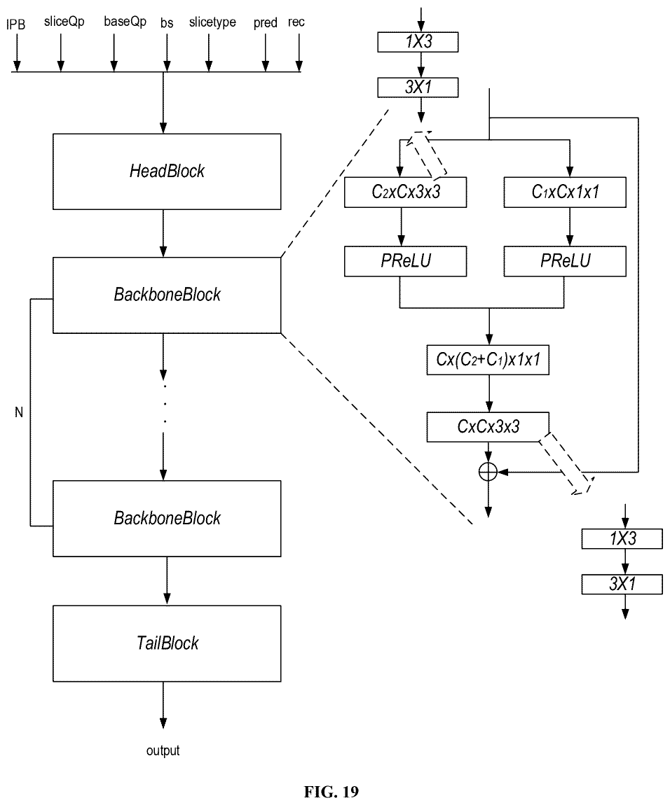

FIG. 19 shows a third example network structure of NN filter which includes Item 2 decomposition, Item 3 side information, Item 4 muti-scale NN structure.

### 5.4. Embodiment 4

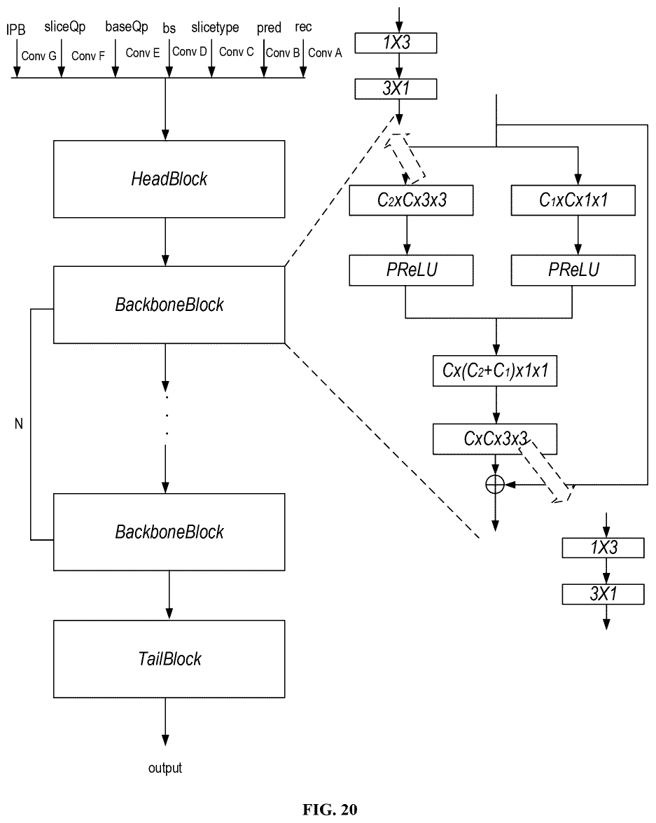

FIG. 20 shows the fourth example network structure of NN filter which includes Item 1 adaptive channel number, Item 2 decomposition, Item 3 side information, Item 4 muti-scale NN structure. The Conv A, Conv B, . . . , Conv G are convolutions with different channel numbers. The larger text font means larger channel numbers, for example, the Conv A is convolution with the largest channel number.

### 5.5. Embodiment 5

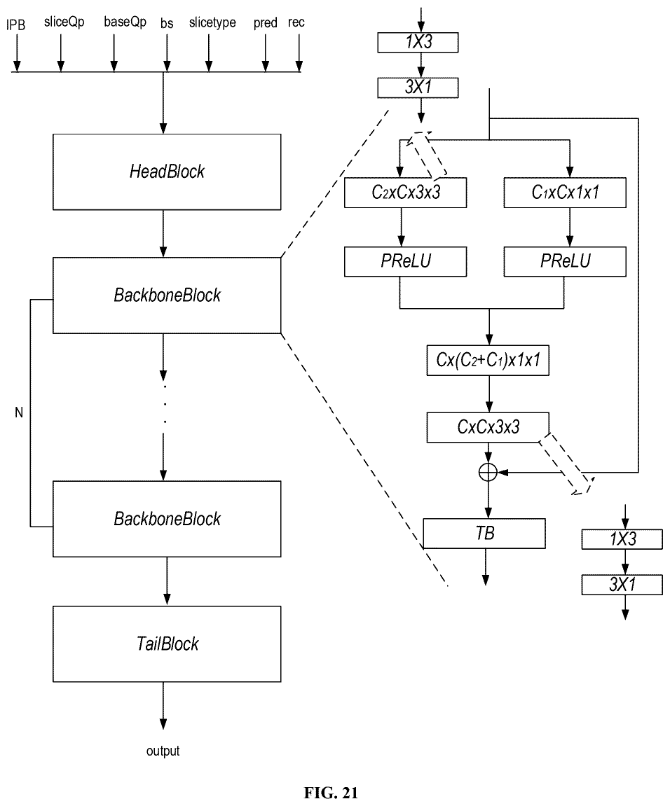

FIG. 21 illustrates the fifth example network structure of NN filter which includes Item 1 adaptive channel number, Item 2 decomposition, Item 3 side information, Item 4 muti-scale NN structure, Item 5 Transformer.

### 5.6. Embodiment 6

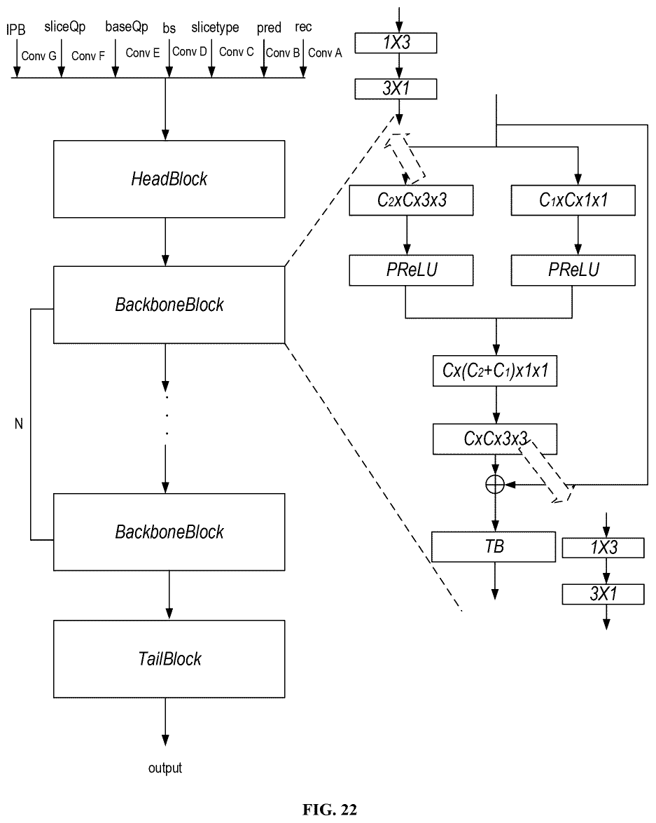

FIG. 22 illustrates the sixth example network structure of NN filter which includes Item 1 adaptive channel number, Item 2 decomposition, Item 3 side information, Item 4 muti-scale NN structure, Item 5 Transformer. The Conv A, Conv B, . . . , Conv G are convolutions with different channel numbers. The larger text font means larger channel numbers, for example, the Conv A is convolution with the largest channel number.

### 5.7. Embodiment 7

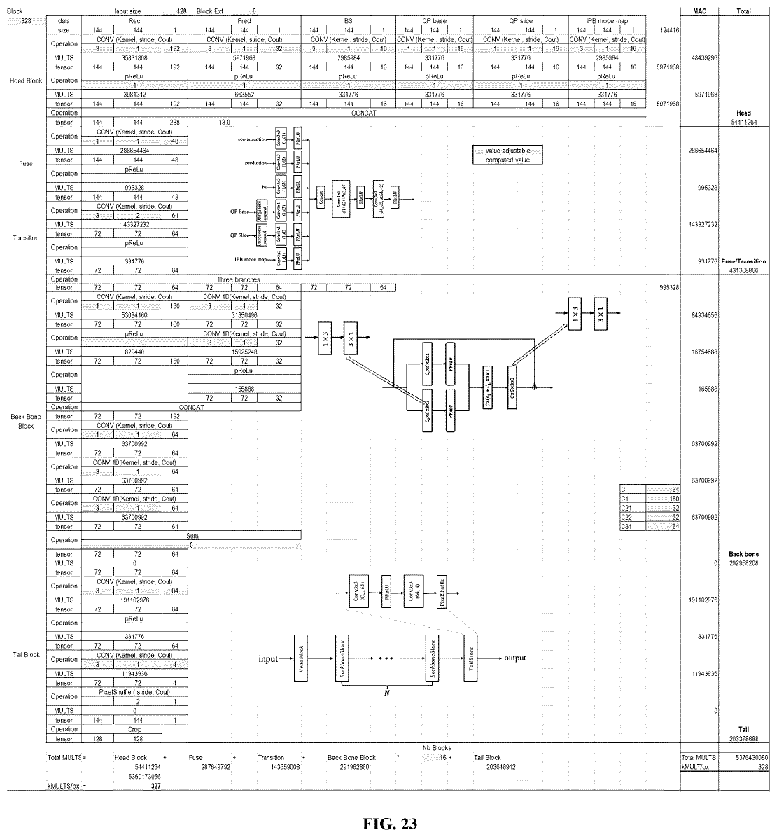

Separate models are used for generating luma and chroma components, respectively. Following figures show the structure of luma model. FIG. 23 is used to show the structure and the number in the table shows the heper-parameters of each convolution layer.

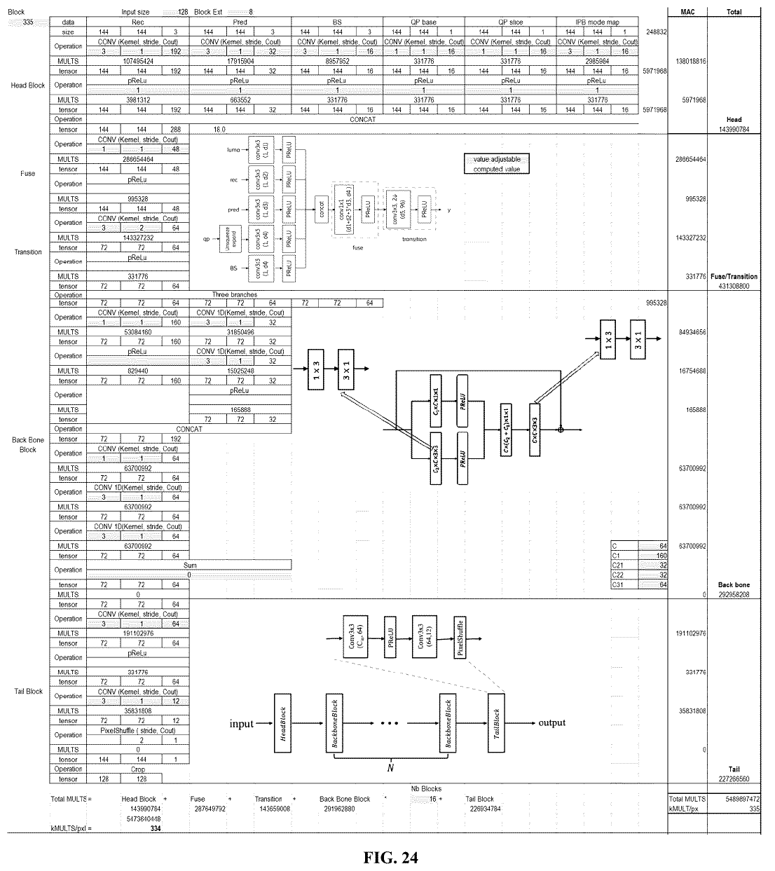

Following FIG. 24 shows the structure of chroma model. FIG. 24 is used to show the structure and the number in the table shows the heper-parameters of each convolution layer.

### 5.8. Embodiment 8

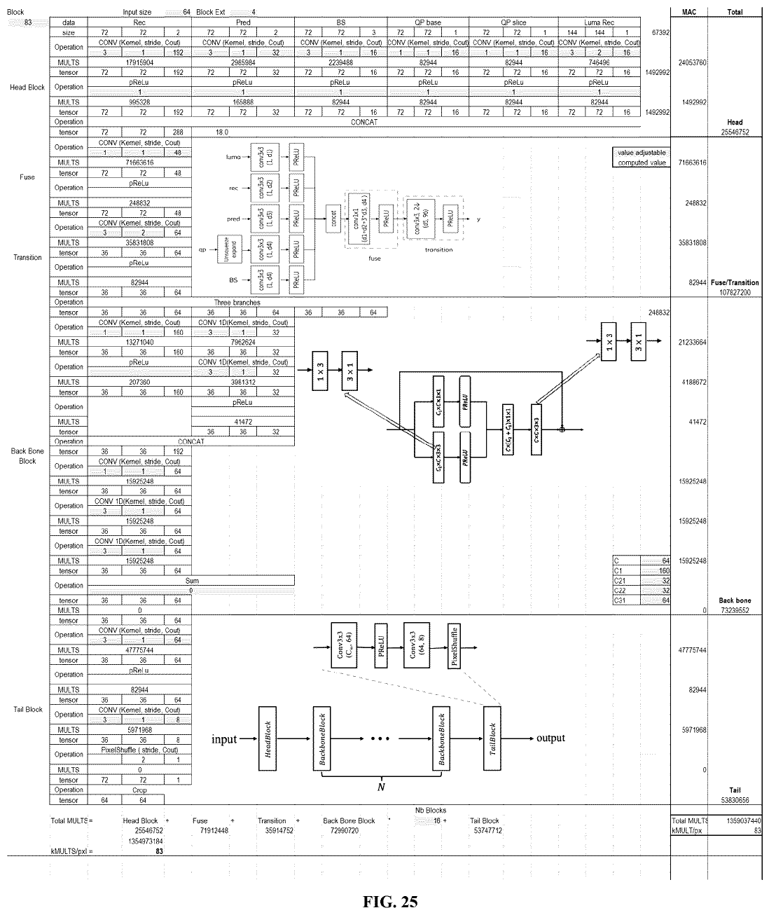

One single model is used for generating the output of luma and chroma components together. FIG. 25 is used to show the structure and the number in the table shows the heper-parameters of each convolution layer.

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one ore multiple CTUs/CTBs, one or multiple Virtual Pipeline Data Unit (VPDU), a sub-region within a picture/slice/tile/brick.

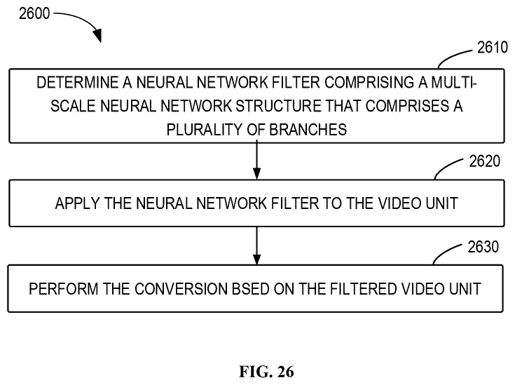

FIG. 26 illustrates a flowchart of a method 2600 for video processing in accordance with embodiments of the present disclosure. The method 2600 is implemented during a conversion between a video unit of a video and a bitstream of the video.

At block 2610, during a conversion between a video unit of a video and a bitstream of the video, a neural network filter is determined. The neural network filter comprises a multi-scale neural network structure that comprises a plurality of branches.

At block 2620, the neural network filter is applied to the video unit.

At block 2630, the conversion is performed based on the filtered video unit. In some embodiments, the conversion may include encoding the video unit into the bitstream. Alternatively, or in addition, the conversion may include decoding the video unit from the bitstream. Compared with the conventional solution where filters are selected directly, the filters can be adaptively combined for the video unit. In this way, the coding effectiveness and coding efficiency can be improved.

In some embodiments, the neural network filter comprises a combination of a plurality of convolutions with smaller kernel size. For example, the convolution with kernel size K×K is decomposed into the plurality of convolutions with smaller kernel size.

In some embodiments, a first convolution is used in a first branch of the plurality of branches and a second convolution is used in a second branch of the plurality of branches. At least one of the followings of the first convolution may be different from that of the second convolution: a kernel size, a channel number, or a stride. In one example, neural network with multiple branches may be used. In each branch, different convolution with different kernel size, channel number, or stride might be used.

In some embodiments, an activation layer is used in the neural network filter. In some embodiments, the activation layer is used after all convolution layers, or wherein the activation layer is used after a part of convolution layers. In some embodiments, the activation layer is a PRelu layer, or wherein the activation layer is a Relu layer. In some embodiments, a residual connection is used.

In some embodiments, the multi-scale neural network structure is used as a basic block in the neural network filter. In some embodiments, the basic block is used for a predetermined number of times. The predetermined number may be an integer greater than 0.

In some embodiments, the basic block is used together with other blocks. In some embodiments, the basic block is used together with other convolution layer and activation layer, and/or wherein the basic block is used together with a residual block.

According to further embodiments of the present disclosure, a non-transitory computer-readable recording medium is provided. The non-transitory computer-readable recording medium stores a bitstream of a video which is generated by a method performed by an apparatus for video processing. The method comprises: determining a neural network filter comprising a multi-scale neural network structure that comprises a plurality of branches; applying the neural network filter to the video unit; applying the neural network filter to a video unit of the video; and generating the bitstream based on the filtered video unit.

According to still further embodiments of the present disclosure, a method for storing bitstream of a video is provided. The method comprises: determining a neural network filter comprising a multi-scale neural network structure that comprises a plurality of branches; applying the neural network filter to the video unit; applying the neural network filter to a video unit of the video; generating the bitstream based on the filtered video unit; and storing the bitstream in a non-transitory computer-readable recording medium.

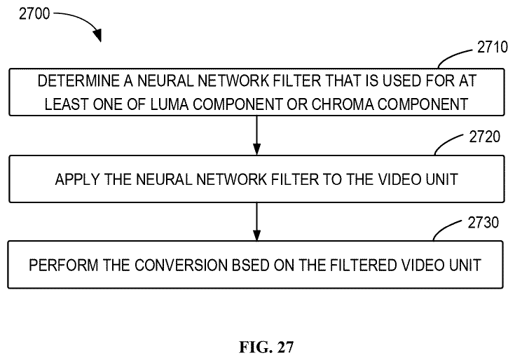

FIG. 27 illustrates a flowchart of a method 2700 for video processing in accordance with embodiments of the present disclosure. The method 2700 is implemented during a conversion between a video unit of a video and a bitstream of the video.

At block 2710, during a conversion between a video unit of a video and a bitstream of the video, a neural network filter is determined. The neural network filter is used for at least one of: luma component or chroma component. Alternatively, or in addition, the neural network filter is used for at least one of: intra slice or inter slice.

At block 2720, the neural network filter is applied to the video unit.

At block 2730, the conversion is performed based on the filtered video unit. determining a neural network filter comprising a multi-scale neural network structure that comprises a plurality of branches; applying the neural network filter to the video unit; applying the neural network filter to a video unit of the video; generating the bitstream based on the filtered video unit; and storing the bitstream in a non-transitory computer-readable recording medium.

In some embodiments, an output of the neural network filter comprises luma components, or chroma components. Alternatively, an output of the neural network filter comprises both luma and chroma components. In some embodiments, a first neural network filter is used for generating an output of luma component and a second neural network filter is used for generating an output of chroma component, respectively.

In some embodiments, a first number of models are used for generating an output of luma component, and a second number of models are used for generating an output of chroma component. In this case, both the first number and the second number may be integers greater than 0. In some embodiments, Cb and Cr components share a same chroma model of the neural network filter.

In some embodiments, a single neural network filter is used for generating an output of luma component and an output of chroma component. In some embodiments, a third number of models are used, and for each model, outputs of luma component and chroma component are generated, where M1 is an integer greater than 0.

In some embodiments, the outputs of luma and chroma components generated by the single neural network filter are used together. In some other embodiments, the outputs of luma and chroma components generated by the single neural network filter are used separately.

In some embodiments, the output of luma component generated by the single neural network is used and the output of chroma component generated by the neural network filter is not used. In some embodiments, the output of luma component generated by the single neural network is not used and the output of chroma component generated by the neural network filter is used.

In some embodiments, a single neural network filter is used for generating filtered outputs for both intra and inter slices. In some embodiments, the intra slice is I slice. In some embodiments, the inter slice is one of: B slice, or P slice, or B and P slices.

According to further embodiments of the present disclosure, a non-transitory computer-readable recording medium is provided. The non-transitory computer-readable recording medium stores a bitstream of a video which is generated by a method performed by an apparatus for video processing. The method comprises: determining a neural network filter, wherein the neural network filter is used for at least one of: luma component or chroma component, and/or the neural network filter is used for at least one of: intra slice or inter slice; applying the neural network filter to the video unit; applying the neural network filter to a video unit of the video; and generating the bitstream based on the filtered video unit.

According to still further embodiments of the present disclosure, a method for storing bitstream of a video is provided. The method comprises: determining a neural network filter, wherein the neural network filter is used for at least one of: luma component or chroma component, and/or the neural network filter is used for at least one of: intra slice or inter slice; applying the neural network filter to the video unit; applying the neural network filter to a video unit of the video; generating the bitstream based on the filtered video unit; and storing the bitstream in a non-transitory computer-readable recording medium.

Implementations of the present disclosure can be described in view of the following clauses, the features of which can be combined in any reasonable manner.

Clause 1. A method of video processing, comprising: determining, during a conversion between a video unit of a video and a bitstream of the video, a neural network filter comprising a multi-scale neural network structure that comprises a plurality of branches; applying the neural network filter to the video unit; and performing the conversion based on the filtered video unit.

Clause 2. The method of clause 1, wherein the neural network filter comprises a combination of a plurality of convolutions with smaller kernel size, and a convolution with kernel size KK is decomposed into the plurality of convolutions with smaller kernel size.

Clause 3. The method of clause 1, wherein a first convolution is used in a first branch of the plurality of branches and a second convolution is used in a second branch of the plurality of branches, at least one of the followings of the first convolution is different from that of the second convolution: a kernel size, a channel number, or a stride.

Clause 4. The method of any of clauses 1-3, wherein an activation layer is used in the neural network filter.

Clause 5. The method of clause 4, wherein the activation layer is used after all convolution layers, or wherein the activation layer is used after a part of convolution layers.

Clause 6. The method of clause 4, wherein the activation layer is a PRelu layer, or wherein the activation layer is a Relu layer.

Clause 7. The method of any of clauses 1-3, wherein a residual connection is used.

Clause 8. The method of clause 1, wherein the multi-scale neural network structure is used as a basic block in the neural network filter.

Clause 9. The method of clause 8, wherein the basic block is used for a predetermined number of times, wherein the predetermined number is an integer greater than 0.

Clause 10. The method of clause 8, wherein the basic block is used together with other blocks.

Clause 11. The method of clause 10, wherein the basic block is used together with other convolution layer and activation layer, and/or wherein the basic block is used together with a residual block.

Clause 12. A method of video processing, comprising: determining, during a conversion between a video unit of a video and a bitstream of the video, a neural network filter, wherein the neural network filter is used for at least one of: luma component or chroma component, and/or the neural network filter is used for at least one of: intra slice or inter slice; applying the neural network filter to the video unit; and performing the conversion based on the filtered video unit.

Clause 13. The method of clause 12, wherein an output of the neural network filter comprises luma components, or chroma components, or both luma and chroma components.

Clause 14. The method of clause 13, wherein a first neural network filter is used for generating an output of luma component and a second neural network filter is used for generating an output of chroma component, respectively.

Clause 15. The method of clause 14, wherein a first number of models are used for generating an output of luma component, and a second number of models are used for generating an output of chroma component, wherein both the first number and the second number are integers greater than 0.

Clause 16. The method of clause 15, wherein Cb and Cr components share a same chroma model of the neural network filter.

Clause 17. The method of clause 1, wherein a single neural network filter is used for generating an output of luma component and an output of chroma component.

Clause 18. The method of clause 17, wherein a third number of models are used, and for each model, outputs of luma component and chroma component are generated, wherein M1 is an integer greater than 0.

Clause 19. The method of clause 17, wherein the outputs of luma and chroma components generated by the single neural network filter are used together.

Clause 20. The method of clause 17, wherein the outputs of luma and chroma components generated by the single neural network filter are used separately.

Clause 21. The method of clause 20, wherein the output of luma component generated by the single neural network is used and the output of chroma component generated by the neural network filter is not used.

Clause 22. The method of clause 20, wherein the output of luma component generated by the single neural network is not used and the output of chroma component generated by the neural network filter is used.

Clause 23. The method of clause 1, wherein a single neural network filter is used for generating filtered outputs for both intra and inter slices.

Clause 24. The method of clause 23, wherein the intra slice is I slice.

Clause 25. The method of clause 24, wherein the inter slice is one of: B slice, or P slice, or B and P slices.

Clause 26. The method of any of clauses 1-25, wherein the conversion includes encoding the video unit into the bitstream.

Clause 27. The method of any of clauses 1-25, wherein the conversion includes decoding the video unit from the bitstream.

Clause 28. An apparatus for video processing comprising a processor and a non-transitory memory with instructions thereon, wherein the instructions upon execution by the processor, cause the processor to perform a method in accordance with any of clauses 1-27.

Clause 29. A non-transitory computer-readable storage medium storing instructions that cause a processor to perform a method in accordance with any of clauses 1-27.

Clause 30. A non-transitory computer-readable recording medium storing a bitstream of a video which is generated by a method performed by an apparatus for video processing, wherein the method comprises: determining a neural network filter comprising a multi-scale neural network structure that comprises a plurality of branches; applying the neural network filter to the video unit; applying the neural network filter to a video unit of the video; and generating the bitstream based on the filtered video unit.

Clause 31. A method for storing a bitstream of a video, comprising: determining a neural network filter comprising a multi-scale neural network structure that comprises a plurality of branches; applying the neural network filter to the video unit; applying the neural network filter to a video unit of the video; generating the bitstream based on the filtered video unit; and storing the bitstream in a non-transitory computer-readable recording medium.

Clause 32. A non-transitory computer-readable recording medium storing a bitstream of a video which is generated by a method performed by an apparatus for video processing, wherein the method comprises: determining a neural network filter, wherein the neural network filter is used for at least one of: luma component or chroma component, and/or the neural network filter is used for at least one of: intra slice or inter slice; applying the neural network filter to the video unit; applying the neural network filter to a video unit of the video; and generating the bitstream based on the filtered video unit.

Clause 33. A method for storing a bitstream of a video, comprising: determining a neural network filter, wherein the neural network filter is used for at least one of: luma component or chroma component, and/or the neural network filter is used for at least one of: intra slice or inter slice; applying the neural network filter to the video unit; applying the neural network filter to a video unit of the video; generating the bitstream based on the filtered video unit; and storing the bitstream in a non-transitory computer-readable recording medium.

### Example Device

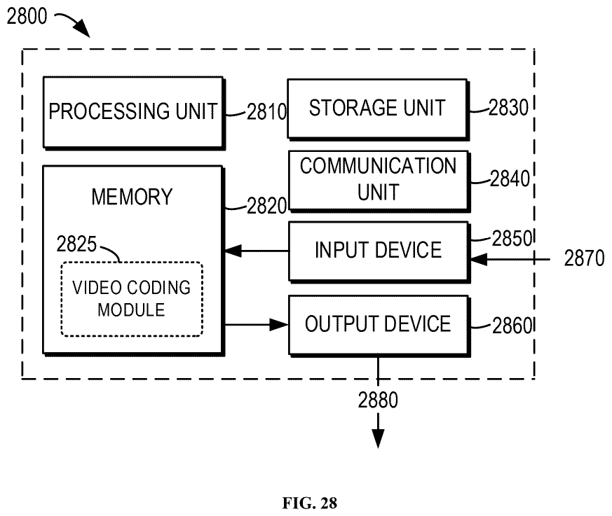

FIG. 28 illustrates a block diagram of a computing device 2800 in which various embodiments of the present disclosure can be implemented. The computing device 2800 may be implemented as or included in the source device 110 (or the video encoder 114 or 200) or the destination device 120 (or the video decoder 124 or 300).

It would be appreciated that the computing device 2800 shown in FIG. 28 is merely for purpose of illustration, without suggesting any limitation to the functions and scopes of the embodiments of the present disclosure in any manner.

As shown in FIG. 28, the computing device 2800 includes a general-purpose computing device 2800. The computing device 2800 may at least comprise one or more processors or processing units 2810, a memory 2820, a storage unit 2830, one or more communication units 2840, one or more input devices 2850, and one or more output devices 2860.

In some embodiments, the computing device 2800 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2800 can support any type of interface to a user (such as “wearable” circuitry and the like).

The processing unit 2810 may be a physical or virtual processor and can implement various processes based on programs stored in the memory 2820. In a multi-processor system, multiple processing units execute computer executable instructions in parallel so as to improve the parallel processing capability of the computing device 2800. The processing unit 2810 may also be referred to as a central processing unit (CPU), a microprocessor, a controller or a microcontroller.

The computing device 2800 typically includes various computer storage medium. Such medium can be any medium accessible by the computing device 2800, including, but not limited to, volatile and non-volatile medium, or detachable and non-detachable medium. The memory 2820 can be a volatile memory (for example, a register, cache, Random Access Memory (RAM)), anon-volatile memory (such as a Read-Only Memory (ROM), Electrically Erasable Programmable Read-Only Memory (EEPROM), or a flash memory), or any combination thereof. The storage unit 2830 may be any detachable or non-detachable medium and may include a machine-readable medium such as a memory, flash memory drive, magnetic disk or another other media, which can be used for storing information and/or data and can be accessed in the computing device 2800.

The computing device 2800 may further include additional detachable/non-detachable, volatile/non-volatile memory medium. Although not shown in FIG. 28, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2840 communicates with a further computing device via the communication medium. In addition, the functions of the components in the computing device 2800 can be implemented by a single computing cluster or multiple computing machines that can communicate via communication connections. Therefore, the computing device 2800 can operate in a networked environment using a logical connection with one or more other servers, networked personal computers (PCs) or further general network nodes.

The input device 2850 may be one or more of a variety of input devices, such as a mouse, keyboard, tracking ball, voice-input device, and the like. The output device 2860 may be one or more of a variety of output devices, such as a display, loudspeaker, printer, and the like. By means of the communication unit 2840, the computing device 2800 can further communicate with one or more external devices (not shown) such as the storage devices and display device, with one or more devices enabling the user to interact with the computing device 2800, or any devices (such as a network card, a modem and the like) enabling the computing device 2800 to communicate with one or more other computing devices, if required. Such communication can be performed via input/output (I/O) interfaces (not shown).

In some embodiments, instead of being integrated in a single device, some or all components of the computing device 2800 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2800 may be used to implement video encoding/decoding in embodiments of the present disclosure. The memory 2820 may include one or more video coding modules 2825 having one or more program instructions. These modules are accessible and executable by the processing unit 2810 to perform the functionalities of the various embodiments described herein.

In the example embodiments of performing video encoding, the input device 2850 may receive video data as an input 2870 to be encoded. The video data may be processed, for example, by the video coding module 2825, to generate an encoded bitstream. The encoded bitstream may be provided via the output device 2860 as an output 2880.

In the example embodiments of performing video decoding, the input device 2850 may receive an encoded bitstream as the input 2870. The encoded bitstream may be processed, for example, by the video coding module 2825, to generate decoded video data. The decoded video data may be provided via the output device 2860 as the output 2880.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

What is claimed is:

1. A method of video processing, comprising:
determining, during a conversion between a video unit of a video and a bitstream of the video, a neural network filter comprising a multi-scale neural network structure that comprises a plurality of branches;
applying the neural network filter to the video unit; and
performing the conversion based on the filtered video unit.

2. The method of claim 1, wherein the neural network filter comprises a combination of a plurality of convolutions with smaller kernel size, and a convolution with kernel size K×K is decomposed into the plurality of convolutions with smaller kernel size, and/or
wherein a first convolution is used in a first branch of the plurality of branches and a second convolution is used in a second branch of the plurality of branches, at least one of the followings of the first convolution is different from that of the second convolution: a kernel size, a channel number, or a stride.

3. The method of claim 1, wherein an activation layer is used in the neural network filter, and/or wherein a residual connection is used.

4. The method of claim 3, wherein the activation layer is used after all convolution layers, or
wherein the activation layer is used after a part of convolution layers, or
wherein the activation layer is a PRelu layer, or
wherein the activation layer is a Relu layer.

5. The method of claim 1, wherein the multi-scale neural network structure is used as a basic block in the neural network filter.

6. The method of claim 5, wherein the basic block is used for a predetermined number of times, wherein the predetermined number is an integer greater than 0, and/or
wherein the basic block is used together with other blocks.

7. The method of claim 6, wherein the basic block is used together with other convolution layer and activation layer, and/or
wherein the basic block is used together with a residual block.

8. The method of claim 1, wherein the neural network filter is used for at least one of: luma component or chroma component, and/or the neural network filter is used for at least one of: intra slice or inter slice.

9. The method of claim 8, wherein an output of the neural network filter comprises luma components, or chroma components, or both luma and chroma components, and/or
wherein a single neural network filter is used for generating an output of luma component and an output of chroma component, and/or
wherein a first neural network filter is used for generating an output of luma component and a second neural network filter is used for generating an output of chroma component, respectively.

10. The method of claim 9, wherein a first number of models are used for generating an output of luma component, and a second number of models are used for generating an output of chroma component, wherein both the first number and the second number are integers greater than 0.

11. The method of claim 10, wherein Cb and Cr components share a same chroma model of the neural network filter.

12. The method of claim 9, wherein a third number of models are used, and for each model, outputs of luma component and chroma component are generated, wherein M1 is an integer greater than 0, and/or
wherein the outputs of luma and chroma components generated by the single neural network filter are used together, and/or
wherein the outputs of luma and chroma components generated by the single neural network filter are used separately.

13. The method of claim 12, wherein the output of luma component generated by the single neural network is used and the output of chroma component generated by the neural network filter is not used, and/or
wherein the output of luma component generated by the single neural network is not used and the output of chroma component generated by the neural network filter is used.

14. The method of claim 1, wherein a single neural network filter is used for generating filtered outputs for both intra and inter slices.

15. The method of claim 14, wherein the intra slice is I slice.

16. The method of claim 15, wherein the inter slice is one of: B slice, or P slice, or B and P slices.

17. The method of claim 1, wherein the conversion includes encoding the video unit into the bitstream, and/or
wherein the conversion includes decoding the video unit from the bitstream.

18. An apparatus for video processing comprising a processor and a non-transitory memory with instructions thereon, wherein the instructions upon execution by the processor, cause the processor to perform a method comprising:
determining, during a conversion between a video unit of a video and a bitstream of the video, a neural network filter comprising a multi-scale neural network structure that comprises a plurality of branches;
applying the neural network filter to the video unit; and
performing the conversion based on the filtered video unit.

19. A non-transitory computer-readable storage medium storing instructions that cause a processor to perform a method comprising:
determining, during a conversion between a video unit of a video and a bitstream of the video, a neural network filter comprising a multi-scale neural network structure that comprises a plurality of branches;
applying the neural network filter to the video unit; and
performing the conversion based on the filtered video unit.

20. A non-transitory computer-readable recording medium storing a bitstream of a video which is generated by a method performed by an apparatus for video processing, wherein the method comprises:
determining a neural network filter comprising a multi-scale neural network structure that comprises a plurality of branches;
applying the neural network filter to a video unit of the video; and
generating the bitstream based on the filtered video unit.
